(19) United States
(12) Patent Application Publication
(10) Pub. No.: US 2025/0111157 A1
(43) Pub. Date: Apr. 3, 2025

(54) ANALYZING EMBEDDING SPACES USING LARGE LANGUAGE MODELS

(71) Applicant: Google LLC, Mountain View, CA (US)

(72) Inventors: Guy Tennenholtz, Menlo Park, CA (US); Yinlam Chow, San Carlos, CA (US); Chih-wei Hsu, Cupertino, CA (US); Jihwan Jeong, Toronto (CA); Lior Shani, Haifa (IL); Deepak Ramachandran, Sunnyvale, CA (US); Martin Mirolyubov Mladenov, Carapicuíba (BR); Craig Edgar Boutilier, Palo Alto, CA (US)

(21) Appl. No.: 18/900,500

(22) Filed: Sep. 27, 2024

Related U.S. Application Data
(60) Provisional application No. 63/541,262, filed on Sep. 28, 2023.

(51) Int. Cl. G06F 40/284; G06F 40/40; G06N 3/0455

(52) U.S. Cl. CPC G06F 40/284; G06F 40/40; G06N 3/0455

(57) ABSTRACT

Methods, systems, and apparatus, including computer programs encoded on a computer storage medium, for analyzing embedding spaces using large language models. In one aspect, a method performed by one or more computers for analyzing a target embedding space using a neural network configured to perform a set of machine learning tasks is described. The method includes: obtaining, for each of one or more entities, a respective domain embedding representing the entity in the target embedding space; receiving a text prompt including a sequence of input tokens describing a particular machine learning task in the set to be performed on the one or more entities; preparing, for the neural network, an input sequence including each input token in the text prompt and each domain embedding; and processing the input sequence, using the neural network, to generate a sequence of output tokens describing a result of the particular machine learning task.

### CROSS-REFERENCE TO RELATED APPLICATION

This application claims priority to U.S. Provisional Application No. 63/541,262, filed on Sep. 28, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes an inference system implemented as computer programs on one or more computers in one or more locations that can use a neural network, e.g., including a large language model, to analyze and interpret domain embeddings of entities via natural language processing tasks. A training system is also described herein that can train the neural network to perform the machine learning tasks.

Embeddings have become a pivotal means to represent complex, multi-faceted information about entities, concepts, and relationships in a condensed and useful format. Nevertheless, they often preclude direct interpretation. While downstream tasks make use of these compressed representations, meaningful interpretation usually involves visualization using dimensionality reduction or specialized machine learning interpretability methods. This specification addresses the challenge of making such embeddings more interpretable and broadly useful, by employing large language models to directly interact with embeddings-transforming abstract vectors into understandable narratives. By injecting embeddings into large language models (or “LLMs”), querying and exploration of complex embedding data is enabled. Experimental results are also provided herein demonstrating this approach on a variety of diverse tasks, including enhancing concept activation vectors (CAVs), communicating novel embedded entities, and decoding user preferences in recommender systems. This specification couples the immense information potential of embeddings with the interpretative power of large language models.

As used herein, a “domain embedding” refers to an ordered collection of numerical values, e.g., a vector, matrix, or other tensor of numerical values, representing an entity in a target embedding space.

As used herein, “an embedding space” refers to a multi-dimensional vector space where data is represented as embedding vectors, e.g., as points or positions in the vector space. The term is commonly used in machine learning, natural language processing, and other data processing systems. Complex entities, such as users, text, video, and images, can represented in this high-dimensional embedding space in such a way that the spatial relationships between embedding vectors captures meaningful relationships between the entities they represent. For example, two words with similar meanings, like “king” and “queen,” might have embedding vectors close to each other in an embedding space.

An entity can belong to a vocabulary of entities, and a domain embedding of the entity may have been generated by an entity encoder, e.g., a neural network that has been trained to encode the particular entities belonging to the vocabulary to the target embedding space. A vocabulary of entities can include users, movies, television shows, audio waveforms, images, point clouds, books, text pieces, generic text, generic items and data items, and so on.

The neural networks described herein can be configured to perform a set of machine learning tasks, e.g., via training the neural network on a respective batch of training examples for each machine learning task in the set. The set of machine learning tasks can include any machine learning task that: (i) operates on a network input that is an input sequence, and (ii) generates a network output that is an output sequence. In general, the neural network includes an encoder neural network and a decoder neural network. The encoder neural network is configured to encode the input sequences into sequences of token embeddings representing the input sequences in a token embedding space, and the decoder neural network is configured to decode the sequences of token embeddings into the output sequences.

An input sequence can include one or more domain embeddings and the input tokens of a text prompt. Each domain embedding represents a respective entity in the target embedding space. The text prompt includes a sequence of input tokens describing, e.g., in a natural language, a particular machine learning task to be performed on the entity(s). In general, the particular machine learning task described by the text prompt reflects some form of semantic information about the entity(s), as represented by their respective domain embeddings. Such semantic information can include, for example, the plot of a movie, television show, or book, the preferences of a user, and so on. The output sequence is a sequence of output tokens describing, e.g., in the natural language, a result of the particular machine learning task performed on the one or more entities.

To map the input sequences to the token embedding space, the encoder neural network includes one or more token embedding layers and one or more adapter embedding layers. The token embedding layer(s) are configured to map each input token in an input sequence to a respective token embedding representing the input token in the token embedding space. Along similar lines, the adapter embedding layer(s) are configured to map each domain embedding in the input sequence to a respective token embedding representing the domain embedding in the token embedding space. Hence, the encoder neural network maps domain embeddings and input tokens to a common, token embedding space. This allows the encoder neural network to generate sequences of token embeddings that include information with respect to the encoded representations of entities along with natural language information about the entities derived from the input tokens. The token embedding layer(s) and the decoder neural network can be a part of (or be derived from) a large language model, e.g., a decoder-only Transformer model. The large language model (or “LLM”) can be augmented with the adapter embedding layer(s) to implement the neural network as an “Embedding Language Model” (or “ELM”) that operates on continuous text prompts using natural language, e.g., as the input sequences include domain embeddings belonging to a continuous embedding space and input tokens belonging to a discrete vocabulary.

A few example applications of the neural network (or ELM) described herein for performing machine learning tasks on such continuous text prompts are provided below.

As one example, if the entities are movies and the target embedding space is a movie embedding space, a particular machine learning task may be to “write a long positive review of a movie.” The input sequence may be: “Write a long positive review for the movie <movie embedding>. Do not use the movie's name in your answer”. Here, <movie embedding> denotes the domain embedding of a specific movie, e.g., Halloweentown High (2004). The neural network can process the input sequence to generate an output sequence that may include: “The movie is about a young witch who goes to a high school in the human world. The witch has to hide her powers from the other students, and she also has to deal with the prejudice of the humans against witches. The movie is well-made, and it has a lot of heart. The characters are well-developed, and the story is engaging. The movie is a great example of a family-friendly Halloween movie. It is not too scary, but it is still entertaining. The movie is also a great way to teach children about tolerance and acceptance. Overall, the movie is a great choice for a family movie night”.

In general, the inference system described herein can use the neural network to process domain embeddings that represent any appropriate type of entity. For example, the entity can include an image, an audio waveform, a point cloud (e.g., generated by a lidar or radar sensor), a protein, a sequence of words (e.g., that form one or more sentences or paragraphs), a video (e.g., represented as a sequence of video frames), or a combination thereof, e.g., multimodal data. The output sequence can characterize the entity or perform a processing task on the entity.

In some implementations, the domain embeddings represent the pixels of an image and the output sequence may include a classification output, e.g., which includes a respective score for each object category in a set of possible object categories, defining a likelihood that the image depicts an object that belongs to the object category.

In some implementations, the domain embeddings represent audio samples in an audio waveform and the inference system is configured to perform speech recognition, i.e., to generate an output sequence that defines a sequence of phonemes, graphemes, characters, or words corresponding to the audio waveform.

In some implementations, the domain embeddings represent words in a sequence of words and the inference system is configured to perform a natural language processing task, e.g., topic classification or summarization. To perform topic classification, the output sequence can include a respective score for each topic category in a set of possible category categories, e.g., the score for a topic category can define a likelihood that the sequence of words pertains to the topic category.

In some implementations, the inference system is configured to perform an audio processing task. For example, if the domain embeddings represent a spoken utterance, then the output sequence may be a score for each of a set of pieces of text, each score representing an estimated likelihood that the piece of text is the correct transcript for the utterance. As another example, if the domain embeddings represent a spoken utterance, the output sequence can indicate whether a particular word or phrase (“hotword”) was spoken in the utterance. As another example, if the domain embeddings represent a spoken utterance, the output sequence can identify the natural language in which the utterance was spoken.

In some implementations, the inference system can perform an image generation task, where the domain embeddings represent a conditioning input, e.g., text, and the output sequence defines a sequence of intensity value inputs for the pixels of an image.

In some implementations, as described further below, the inference system can perform an agent control task, where the domain embeddings represent a sequence of one or more observations and/or other data characterizing states of an environment and the output sequence describes how the agent should be controlled. The agent can be, e.g., a real-world or simulated mechanical agent (such as a robot or vehicle), a control system for an industrial facility, or a control system that controls a different kind of agent.

In some implementations, the inference system can perform a point cloud processing task, e.g., where the domain embeddings represent a point cloud (e.g., generated by a lidar or radar sensor) and the output sequence characterizes, e.g., a type of object represented by the point cloud.

In some implementations, the inference system is configured to perform a combination of multiple individual machine learning tasks, e.g., two or more of the machine learning tasks mentioned above.

The inference system can use the neural network to process multimodal domain embeddings of a multimodal entity. Such an entity may include a combination of different types of data, such as image or video data and audio data, image or video data and language data, image or video data and user data, somatosensory input data (sensor data sensing the real-world environment of a physical agent, such as sensing touch, pressure, movement, temperature or vibration data) and motor feedback data (i.e., control data to control movement of the physical agent). When a multimodal domain embedding is analyzed by the inference system, domain embeddings of the data elements of the different modalities may be combined, e.g., via a weighted sum or other appropriate combinational method.

These and other aspects of the inference system and neural network described herein are summarized below.

According to a first aspect there is provided a method performed by one or more computers for analyzing a target embedding space using a neural network configured to perform a set of machine learning tasks. The method includes: obtaining, for each of one or more entities, a respective domain embedding representing the entity in the target embedding space; receiving a text prompt comprising a sequence of input tokens describing a particular machine learning task in the set to be performed on the one or more entities; preparing, for the neural network, an input sequence comprising each input token in the text prompt and each domain embedding representing its respective entity; and processing the input sequence, using the neural network, to generate a sequence of output tokens describing a result of the particular machine learning task, wherein the neural network comprises: an encoder neural network configured to: receive the input sequence; and process the input sequence to generate a sequence of token embeddings representing the input sequence in a token embedding space; and a decoder neural network configured to: receive the sequence of token embeddings; and process the sequence of token embeddings to generate the sequence of output tokens describing the result of the particular machine learning task.

In some implementation of the method, the sequence of token embeddings comprises, for each input token and domain embedding in the input sequence, a respective token embedding representing the input token or domain embedding in the token embedding space.

In some implementation of the method, the encoder neural network comprises: one or more token embedding layers configured to: receive each input token in the input sequence; and process the input token to generate the respective token embedding representing the input token in the token embedding space; and one or more adapter embedding layers configured to: receive each domain embedding in the input sequence; and process the domain embedding to generate the respective token embedding representing the domain embedding in the token embedding space.

In some implementation of the method, the one or more token embedding layers and the decoder neural network are part of a large language model.

In some implementation of the method, the large language model is a decoder-only Transformer model.

In some implementation of the method, obtaining, for each of the one or more entities, the respective domain embedding representing the entity in the target embedding space comprises: selecting the one or more entities from a vocabulary of entities; and processing each of the one or more entities, using an entity encoder, to generate the respective domain embedding representing the entity in the target embedding space.

In some implementation of the method, obtaining, for each of the one or more entities, the respective domain embedding representing the entity in the target embedding space comprises: sampling, for each of the one or more entities, the respective domain embedding representing the entity from a probability distribution over the target embedding space.

In some implementation of the method, for each machine learning task in the set, the neural network has been trained on a respective batch of training examples to perform the machine learning task.

In some implementation of the method, for each machine learning task in the set, the respective batch of training examples for the machine learning task was obtained by operations comprising: obtaining a training text prompt describing the machine learning task; and for each training example in the batch: obtaining, for each of one or more training entities, a respective domain embedding representing the training entity in the target embedding space; preparing a training input sequence comprising each token in the training text prompt and each domain embedding representing its respective training entity; obtaining a target output sequence describing a target result of the machine learning task performed on the one or more training entities; and generating the training example from the training input sequence and the target output sequence.

In some implementation of the method, for each training example in the batch, obtaining the target output sequence for the training example comprised: inserting, for each of the one or more training entities, a respective token describing the training entity into the training text prompt; and processing the training text prompt, using a large language model, to generate the target output sequence.

In some implementation of the method, the decoder neural network is pre-trained, and training the neural network on the batches of training examples comprised: training the encoder neural network on the batches of training examples while holding the decoder neural network frozen.

In some implementation of the method, training the neural network on the batches of training examples further comprised, after training the encoder neural network on the batches of training examples, fine-tuning both of the encoder and decoder neural networks on the batches of training examples.

In some implementation of the method, the neural network has been trained using a maximum likelihood learning algorithm.

In some implementation of the method, the neural network has been trained using a reinforcement learning algorithm.

In some implementation of the method, the reinforcement learning technique is a reinforcement learning from AI feedback technique.

In some implementation of the method, the target embedding space is equipped with a distance metric, and the method further comprises: processing the sequence of output tokens, using a text encoder neural network, to generate one or more new domain embeddings in the target embedding space; computing, using the distance metric, a similarity between: (i) the one or more domain embeddings, and (ii) the one or more new domain embeddings; and determining whether the similarity is above a threshold similarity value.

In some implementation of the method, the text encoder neural network is a pre-trained dual-encoder language model.

In some implementation of the method, the target embedding space comprises domain embeddings representing one or more of: users, items, movies, television shows, audio waveforms, images, point clouds, or text pieces.

In a second aspect, a system is provided. The system includes one or more computers and one or more storage devices communicatively coupled to the one or more computers, wherein the one or more storage devices store instructions that, when executed by the one or more computers, cause the one or more computers to perform the method of the first aspect in any of its abovementioned implementations.

In a third aspect, one or more non-transitory computer storage media is provided. The one or more non-transitory computer storage media store instructions that, when executed by one or more computers, cause the one or more computers to perform the method of the first aspect in any of its abovementioned implementations.

The subject matter described in this specification can be implemented in particular embodiments so as to realize one or more of the following advantages.

The success of deep learning has brought forth a paradigm shift in knowledge representation through the concept of embeddings-dense vectors, arrays, matrices, or tensors that capture high-dimensional information about entities, concepts, or relationships in a compact and useful representation. Embeddings are ubiquitous, finding applications in natural language processing, recommender systems, protein sequence modeling, and more. These embeddings capture nuanced relationships and semantic structure in data which traditional machine learning approaches often miss. However, understanding these abstract representations remains challenging. By design, the structure and underlying information carried by an embedding is heavily adapted to the idiosyncrasies of the downstream task, posing a substantial challenge to its interpretation and manipulation.

To overcome these challenges, this specification introduces an inference system for interpreting domain embeddings using natural language by leveraging the power of large language models (or “LLMs”). The inference system introduces domain embeddings into LLMs using one or more adapter embedding layers that have been trained to map domain embeddings into a token-level embedding space of an LLM, which in turn allows the inference system to treat these domain embeddings as token-level embeddings of the entities or concepts they represent. This specification also introduces a training system for training a neural network, that includes the adapter embedding layer(s) and an LLM, on a set of machine learning tasks designed to facilitate robust, generalizable interpretation of domain embeddings in the target embedding space. Upon training, the inference system can engage in a direct “dialogue” about these domain embeddings, by querying the neural network with domain embeddings, and thereby determine narratives and insights from these dense representations.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a schematic diagram depicting an example of an inference system configured to analyze a target embedding space using a neural network.

FIG. 1B is an illustration of an example implementation of the inference system for performing three movie-related tasks on movies represented in a movie embedding space using the neural network.

FIG. 1C is a flow diagram of an example process for analyzing a target embedding space using a neural network.

FIG. 2A is a schematic diagram depicting an example of a training system configured to train a neural network to perform a set of machine learning tasks.

FIG. 2B is a schematic diagram depicting an example implementation of the training system generating a training example for a machine learning task using a large language model.

FIG. 2C is an illustration of an example implementation of the training system for training the neural network to perform a set of movie-related tasks on a movie embedding space.

FIG. 2D is a flow diagram of an example process for training a neural network to perform a set of machine learning tasks.

FIG. 3A is an experimental plot of consistency results for interpolated movie and users in an experiment on the MovieLens 25M dataset.

FIG. 3B is a plot of semantic consistency of movie interpolations for the five positive characteristics task in the MovieLens 25M experiment.

FIG. 3C is a plot of semantic consistency of interpolations of movies for the long description task in the MovieLens 25M experiment.

FIG. 3D is an experimental plot of behavior consistency results for concept activation vector extrapolations of user profiles in the MovieLens 25M experiment.

FIG. 4A is a schematic diagram depicting an example implementation of Semantic Consistency (SC) testing applied to a movie embedding space.

FIG. 4B is a schematic diagram depicting an example implementation of Behavioral Consistency (BC) testing applied to a user embedding space.

FIG. 5 shows an example of a Google Form presented to human-raters in the MovieLens 25M experiment.

Like reference numbers and designations in the various drawings indicate like elements.

### DETAILED DESCRIPTION

The success of deep learning has brought forth a paradigm shift in knowledge representation through the concept of embeddings-dense vector, array, matrix, or tensorial representations that capture high-dimensional information about entities, concepts, or relationships in a compact and useful format. Embeddings are ubiquitous, finding application in natural language processing, recommender systems, protein sequence modeling, and more. These embeddings are invaluable, capturing nuanced relationships and semantic structure in data which traditional machine learning approaches often miss. Nevertheless, understanding these abstract representations remains challenging.

By design, the structure and underlying information carried by an embedding is heavily adapted to the idiosyncrasies of the downstream task, posing a substantial obstacle to its interpretation and manipulation. Previous work on machine learning interpretability offers various task-independent means to interpret embeddings, including dimensionality reduction techniques (e.g., t-SNE, UMAP) or concept activation vectors (CAVs). While useful, these techniques are fairly narrow in scope.

As an alternative to such interpretability methods, this specification introduces an inference system capable of engaging with embeddings using task-based natural language processing, for example, to query information not directly expressed by the name or description of the underlying entity or concept. This allows the inference system to extract information even from embedding representations of non-existent or hypothetical entities.

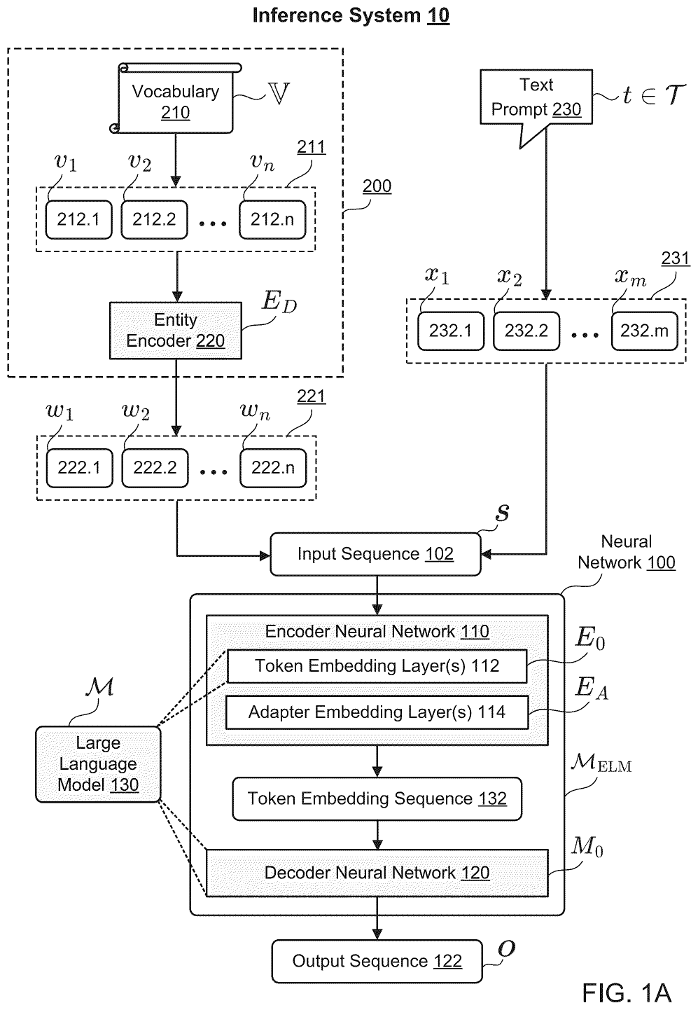

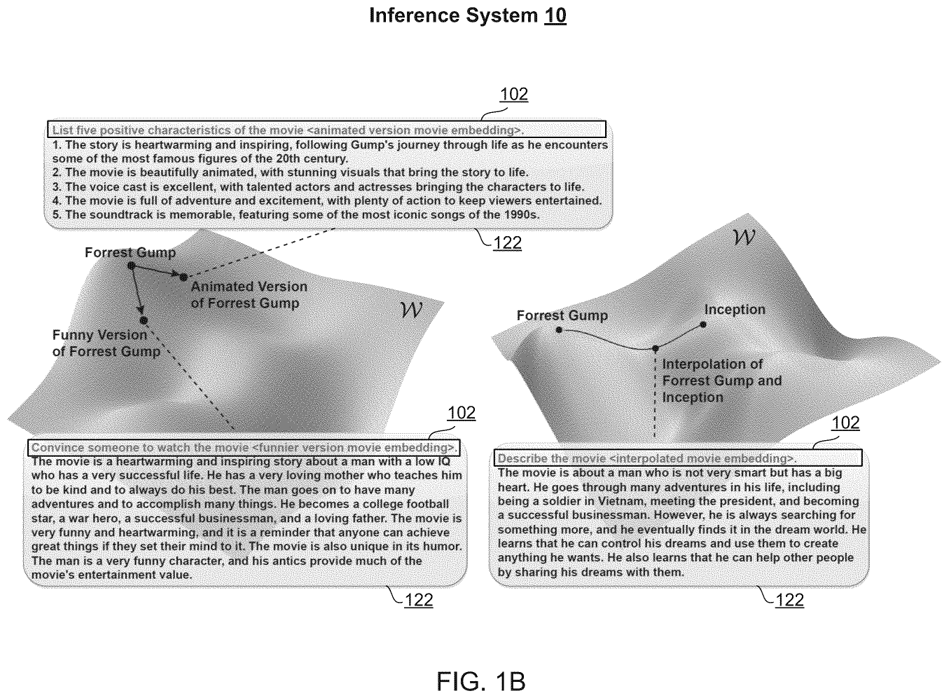

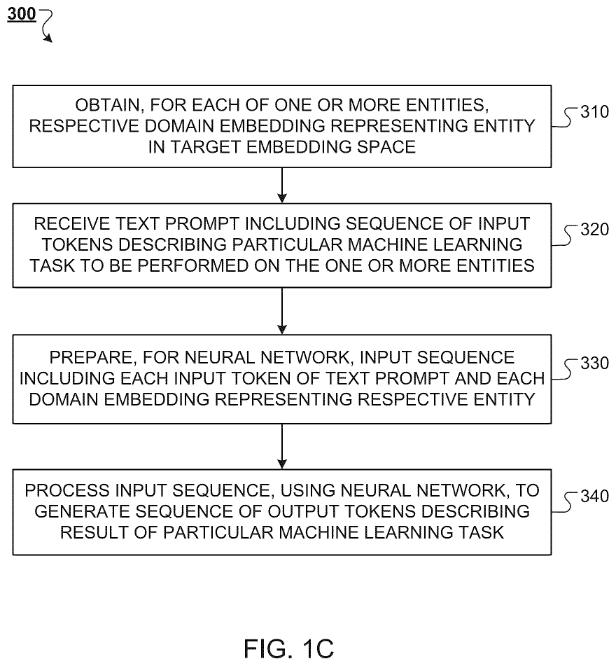

For example, consider a target embedding space representing molecules from a chemical or biological database, where an encoder has been trained to the target embedding space using a large corpus of molecular and clinical data, e.g., including molecular sequences and structures, poses, conformers, binding affinities and free energies, interaction strengths, solubilities, toxicities, bioavailability, and other-multifaceted molecular data. The embedding representation of a molecule, such as ligand, can implicitly embody intricate details about its therapeutic effect, potency, drug interaction, side effects, and other features. Moreover, suppose one wanted to understand the properties of a yet unsynthesized ligand at a specific point in the embedding space, say, to design a therapeutic drug including such a ligand. Since no experimental or clinical data of the ligand exists, querying a conventional language model to describe this point in the embedding space would be futile. However, as demonstrated in this specification, a large language model (or “LLM”) trained to interpret the embedding representation itself can handle such a task, see FIG. 1B for an illustration on hypothetical movies in a movie embedding space.

As another example, consider a target embedding space representing items from an online commerce site, where an encoder has been trained to the target embedding space using a large corpus of textual data, e.g., including user ratings, purchases, reviews, and other multi-faceted data sources. The embedding representation of an item can implicitly embody intricate details about its quality, usability, design, customer satisfaction, and other features. One may want to understand the properties of a hypothetical item at a specific point in the embedding space, say, to forecast a potential market for such an item. Again, since no such item or description of the item exists, querying a conventional language model to describe this point in the embedding space would be futile.

To this end, this specification introduces a novel machine learning framework for interpreting domain embeddings by leveraging the power of LLMs. The systems and methods provided herein seamlessly introduce embeddings into LLMs by training one or more adapter embedding layers to map domain embeddings residing in a target embedding space to the token-level embedding space of an LLM, which in turn allows the LLM to treat these domain embeddings as token-level encodings of the entities or concepts they represent. Experimental results are provided herein that involved training an LLM on a collection of tasks designed to facilitate the robust, generalizable interpretation of domain embeddings in a target embedding space, e.g., including movie, user, and product embedding spaces. This approach allows the inference system to engage in a direct “dialogue” about these domain embeddings, to query the LLM with intricate embedding data, and tease out narratives and insights from these dense representations.

The contributions of this specification are as follows. First, the problem of interpreting embeddings using LLMs is formulated. A neural network, termed the “Embedding Language Model” (or “ELM”) is introduced, a novel language model which, using trained adapter embedding layers, can accept domain embeddings as parts of its textual input sequence to allow interpretation of continuous prompts using natural language. A training methodology to fine-tune pretrained LLMs for domain-embedding interpretation is also described. Finally, the neural network (or ELM) is tested in experiments involving twenty-five training tasks to allow interpretation of movie and user embeddings derived from the MovieLens 25M dataset. The proficiency of the trained ELM was also verified on a variety of problems, including: generalizing CAVs as an interpretability method, describing hypothetical embedded entities, and interpreting user embeddings in a recommender system by generating preference profiles. The systems and methods provided herein bridge the gap between the rich data representations of domain embeddings and the expressive capabilities of LLMs.

These features and other features are described in more detail below.

FIG. 1A is a schematic diagram depicting an example of an inference system 10 configured to analyze a target embedding space using a neural network 100. The inference system 10 is an example of a system implemented as computer programs on one or more computers in one or more locations in which the systems, components, and techniques described below are implemented.

More particularly, the inference system 10 is configured to analyze a target embedding model 200 using the neural network 100. In general, the target embedding model 200 represents the embedding model of a target, system of interest, e.g., a recommender system, an image classification system, a search and retrieval system, a natural language processing system, a multimodal (e.g., text and image) system, a computer vision system, a social media platform, a voice and speech system, an e-commerce and retail system, a health care system, a legal document and analysis system, a finance and fraud detection system, an autonomous and robotics system, a content moderation and detection system, a chatbot or virtual assistant, a bioinformatics system, a game AI and interactive system, and so on. The target embedding model 200 includes a vocabulary (V) 210 of entities 212 related to the system of interest, and an entity encoder (ED) 220 that implements the embedding model on the vocabulary 210 for the system of interest. That is, the entity encoder 220 encodes entities in the vocabulary 210 to the target embedding space.

In general, the vocabulary 210 can be any set or database of distinguishable entities, e.g., including generic users or profiles, generic objects or items, and generic data objects or items. Hence, the term “entity” is used broadly herein. For example, the vocabulary 210 can be a database of users and items of an online e-commerce website. The vocabulary 210 can be a database of users, movies, and television shows of a video-streaming service. The vocabulary 210 can be a database of users and images of an online image-repository. The vocabulary 210 can be a database of users and restaurants of an online rating website. The vocabulary 210 can be a database of doctors, patients, medical records, prescriptions, and procedures of a hospital. The vocabulary 210 can be a chemical or biological database of proteins, ligands, and other molecules that are candidates for therapeutic drug discovery, and so on. A non-exhaustive, non-limiting list of different entities that can be included in the vocabulary 210 is provided below.

Examples of entities include, but are not limited to: general entities such as persons, places, locations, events, employees, customers, suppliers, products, orders, invoices, payments, companies, branches, departments, projects, tasks, events, appointments, shipments, inventory items, assets, loans, and contracts; business and finance entities such as accounts, transactions, ledgers, tax records, expenses, revenues, budgets, investments, bonds, stocks, dividends, invoice line items, sales receipts, expense reports, and purchase orders; technology and IT entities such as user accounts, sessions, logs, files, servers, networks, IP addresses, subnets, databases, tables, columns, rows, primary keys, foreign keys, and domains; education entities such as students, teachers, professors, administration persons, courses, assignments, grades, exams, classrooms, departments, programs, semesters, enrollments, degrees, and textbooks; healthcare entities such as patients, doctors, nurses, prescriptions, medical records, test results, treatments, procedures, diagnoses, hospitals, clinics, insurance policies, and claims; real estate entities such as properties, buildings, apartments, tenants, leases, landlords, mortgages, titles, inspections, real estate agents, maintenance requests, property sales, and zonings; e-commerce entities such as products, items, shopping carts, product categories, product reviews, discounts, coupons, shipments, returns, wishlists, fulfillment centers, payment methods, and subscription plans; manufacturing and supply chain entities such as suppliers, warehouses, raw materials, finished products, bills of materials, production orders, machines, robots, workstations, shifts, and factories; legal entities such as cases; attorneys, judges, courts, verdicts, law firms, contracts, settlements, patents, trademarks, licenses, and agreements; travel and hospitality entities such as hotels, flights, tickets, reservations, tour packages, car rentals, guests, travel agencies, destinations, and tour guides; human resource entities such as employees, job positions, salaries, bonuses, payrolls, time sheets, performance reviews, benefit plans, leave requests, and training programs; government entities such as citizens, voters, legislations, permits, licenses, census records, taxpayers, regulations, subsidies, public services, and grants; science and research entities such as research papers, scientists, subjects, laboratories, laboratory equipment, conferences, experiments, samples, datasets, hypotheses, theories, variables, and observations; social media entities such as posts, pictures, videos, comments, likes, friends, followers, user profiles, groups, messages, and notifications; marketing entities such as campaigns, ads, leads, segment, marketing channels, promotions, conversions, newsletters, and surveys; sports entities such as teams, players, coaches, games, matches, practices, seasons, championships, scores, tournaments, venues, and fans; transportation entities such as vehicle drivers, routes, bus stops, trains, stations, cargos, passengers, flight numbers, and ports; multimedia and image-based entities such as images, movies, films, videos, livestreams, audio, animations, three-dimensional models, point clouds, gifs, audio, text, video games, augmented or virtual reality objects and environments, multimedia file formats (e.g., JPEG, PNG, MP3, WAV, MP4, and FLV), books, flyers, brochures, presentations and slideshows, characters, and actors; and molecular entities such as atoms, ions, and molecules (e.g., proteins, ligands, peptides, and nucleic acids).

In general, the entity encoder 220 is configured to process an entity in the vocabulary 210 (or data characterizing and/or identifying the entity in the vocabulary 210) to generate a domain embedding representing the entity in a target embedding space (W). For example, if the entity is a digital entity such as a video, image, audio waveform, text piece or other digital item, the entity encoder 220 can process the digital entity itself to generate the domain embedding. Alternatively, if the entity is a real-world entity such as a person, place, or protein, the entity encoder 220 can process data characterizing and/or identifying the real-world entity in the vocabulary 210. For example, the entity encoder 220 may process a chemical formula, a three-dimensional model, and/or clinical trial data of a real-world protein to generate the domain embedding of the real-world protein. As another example, the entity encoder 220 may process a unique identifier of a real-world employee on a company list, e.g., a one-hot vector or integer identifier for the real-world employee, to generate the domain embedding of the real-world employee. In some cases, the entity encoder 220 may also process data characterizing and/or identifying a digit-entity in a similar fashion as a real-world entity, as opposed to processing the digital-entity itself. For example, as demonstrated in the MovieLens experiment section, a pretrained dual-encoder language model (DLM) was implemented as the entity encoder 220 to generate “semantic embeddings” of movies from textual descriptions of the movies.

In any case, the entity encoder 220, represented as ED: [symbol] → [symbol] , maps entities ν∈ [symbol] in the vocabulary 210 to respective domain embeddings w E W in the target embedding space, such that w=E_{D}(ν). In general, the target embedding space is equipped with a distance metric d: W×W→ [symbol] ₊, which takes two domain embeddings as input and returns a positive scalar as output, such that d (w₁, w₂)≥0. For example, the distance metric can measure a Euclidean, cosine, or L-norm distance between two domain embeddings. The entity encoder 220 is typically a neural network that has been trained to encode latent features of the entities 212 to the target embedding space, e.g., with reduced dimensionality. For example, if the entities 212 are images, the entity encoder 220 can be an image encoder neural network. If the entities 212 are videos, the entity encoder 220 can be a video encoder neural network. If the entities 212 are audio waveforms, the entity encoder 220 can be an audio encoder neural network. If the entities are text pieces, the entity encoder 220 can be a text encoder neural network, and so on. The entity encoder 220 can also be a multimodal encoder neural network, or include multiple encoder neural networks, if the entities include more than one type of entity, e.g., entities including two or more of: users, images, videos, audio waveforms, and text pieces.

A domain embedding E_{D}(ν)∈ [symbol] of an entity ν∈ [symbol] is typically a representation employed in one or more downstream tasks of the system of interest, where the entity encoder 212 has been trained to encompass the latent features of v involved in these task(s). For example, in recommender systems, collaborative filtering (or “CF”) is often used to generate domain embeddings of users (u) and items (i) such that the dot product (or cosine similarity) of E_{D}(u) and E_{D}(i) is predictive of user u's affinity for item i. In image classification systems, the entity encoder 212 might generate domain embeddings useful for object detection, while in search and information retrieval systems, the entity encoder might embed both queries and documents in the target embedding space ( [symbol] ) to measure a document's relevance to a query.

Note, the term “domain embedding” is used herein to specifically identify external embeddings belonging to the target embedding space that are to be interpreted by the neural network 100. Hence, domain embeddings should not be confused with other possible internal embeddings of the neural network 100, e.g., token embeddings, that the neural network 100 uses for natural language processing. It is also worth mentioning that the inference system 10 may not have direct access to the target embedding model 200 itself, that is, the vocabulary 210 and/or the entity encoder 220. For example, the inference system 10 can be implemented only with access to the target embedding space and its distance metric ( [symbol] , d). The inference system 10 is also agnostic to the type and source of ( [symbol] , d). Moreover, a training system 20 described hereinafter, can be implemented only with pairs of training entities and domain embeddings thereof (ν, E_{D}(ν)), with the entity encoder 220 providing empirical evaluation if accessible.

The neural network ( [symbol] _{ELM}) 100, referred to herein as an “Embedding language model” (or “ELM”), includes an encoder neural network (E₀×E_{A}) 110 and a decoder neural network (M₀) 120. The model of the neural network 110 is represented as [symbol] _{ELM}=((E₀×E_{A})^{H}, M₀). As shown in FIG. 1A, the encoder neural network 110 includes one or more token embedding layers (E₀) 112 and one or more adapter embedding layers (E_{A}) 114.

The encoder neural network 110 is the “sparse” component of the neural network 110 that performs element-to-element encoding. That is, the encoder neural network 110 typically has fewer parameters than the decoder neural network 120. Hence, the encoder neural network 110 may include a few neural network layers, e.g., 2 layers or less, 3 layers or less, 4 layers or less, or 5 layers or less. For example, each of the token embedding layer(s) 112 and adapter embedding layer(s) 144 can include a fully-connected layer, a convolutional layer, or a self-attention layer, etc. In some implementations, the encoder neural network 110 can have 100 million parameters or less, 10 million parameters or less, a million parameters or less, 100 thousand parameters or less, 10 thousand parameters or less, or a thousand parameters or less.

The decoder neural network 120 is the “dense” component of the neural network 100 that performs sequence-to-sequence decoding. For example, the decoder neural network 120 can be a generative neural network, e.g., the decoder of a large language model (or “LLM”), such as a decoder-only Transformer model. More generally, the decoder neural network 120 can include any appropriate types of neural network layers (e.g., fully-connected layers, convolutional layers, self-attention layers, etc.) in any appropriate numbers (e.g., 5 layers or more, 25 layers or more, or 100 layers or more) and connected in any appropriate configuration (e.g., as a linear sequence of layers, residual configurations, etc.). In some implementations, the decoder neural network 120 can have a billion parameters or more, 10 billion parameters or more, 100 billion parameters or more, 200 billion parameters or more, 300 billion parameters or more, 400 billion parameters or more, 500 billion parameters or more, 600 billion parameters or more, 700 billion parameters or more, 800 billion parameters or more, 900 billion parameters or more, or a trillion parameters or more.

In this implementation, the token embedding layer(s) 112 and the decoder neural network 120 are part of (or are derived from) a pre-trained LLM, where [symbol] =(E₀^{H}, M₀) is the model of the LLM 130. For example, the LLM 130 can be a text-only LLM or a multi-modal LLM. Hence, the LLM 130 can be configured as an LLM in any of the GPT series, BERT series, mBERt Series, T5 series, Flan-T5 series, LaMDA series, LLAMA series, PALM series, UL2 series, EleutherAI series, BLOOM series, OPT series, Megatron series, Gopher series, Chinchilla series, ERNIE series, Turing-NLG series, Cohere series, XLM-R series, Jurassic-1 series, Pegasus series, Codex series, or the like. In general, the LLM 130 is configured to: receive a first sequence of language tokens (e.g., describing a machine learning task in a natural language); and process the first sequence of language tokens to generate second, different sequence of language tokens (e.g., describing a result of the machine learning task in the natural language). In other words, the LLM 130, represented as [symbol] : [symbol] ^{H} [symbol] [symbol] ^{H}, maps length H sequences of language tokens into one another, where x∈ [symbol] is a language token in a language token vocabulary ( [symbol] ). To accomplish this, the token embedding layer(s) 112 and the decoder neural network 120 of the LLM 130 have been pre-trained on a text corpus, e.g., a large collection of text such as the Internet.

The token embedding layer(s) 112 are configured to: receive a language token (x); and process the language token to generate a token embedding (z) representing the language token in a token embedding space ( [symbol] ). In other words, the token embedding layer(s) 112, represented as E₀: [symbol] , map language tokens x∈ [symbol] in the language token vocabulary to respective token embeddings z∈ [symbol] in the token embedding space, such that z=E₀(x). Note, token embeddings are distinct from (and not to be confused with) domain embeddings as they belong to distinct embedding spaces.

The decoder neural network 120 is configured to: receive a sequence of token embeddings; and process the sequence of token embeddings to generate a sequence of language tokens. In other words, the decoder neural network 120, represented as M₀: [symbol] , maps sequences of token embeddings into sequences of language tokens.

The adapter embedding layer(s) 112 are configured to: receive a domain embedding; and process the domain embedding to generate a token embedding representing the domain embedding in the token embedding space. The adapter embedding layer(s) 112, represented as E_{A}: [symbol] , map domain embeddings w∈ [symbol] in the target embedding space to respective token embeddings z∈ [symbol] in the token embedding space, such that z=E_{A}(w). Hence, the token embedding layer(s) 112 and the adapter embedding layer(s) 114 map language tokens and domain embeddings, respectively, to a common, token embedding space. The adapter embedding layer(s) 112 are incorporated by the neural network 100 to interface with the LLM 130, particularly the decoder neural network 120, allowing the neural network 100 to process textual prompts mixed with continuous domain embeddings and, thus, interpret the target embedding space. For example, the adapter embeddings layer(s) 112 allow the LLM 130 to engage in discourse about an entity v represented by its respective domain embedding w=E_{D}(ν), even if the entity is hypothetical or non-existent, e.g., the entity ν∉ [symbol] does not belong to the vocabulary 210.

To interpret the target embedding space, the neural network 100 is configured to perform a set of machine learning tasks ( [symbol] ), e.g., via appropriate training by the training system 20. Each machine learning task t∈ [symbol] is specified by a mapping from joint input sequences s∈( [symbol] U [symbol] )^{H} of language tokens and domain embeddings, to distributions over output sequences o ∈ [symbol] ^{H} of language tokens. Intuitively, a machine learning task (t) reveals the semantic information about the entity represented by w∈ [symbol] , such as the plot of a movie or television show, the scene depicted in an image, the genre of a song, the prose of a text piece, the configuration of a protein, the preferences of a user, etc. In general, the set of machine learning tasks ( [symbol] ) is diverse enough that the neural network 100 can extract information from the target embedding space ( [symbol] ) to support interpretation and, in some implementations, supports generalization to other, related machine learning tasks.

The inference system 10 can then analyze the target embedding space using the neural network 100 as follows.

The inference system 10 obtains a set 221 of one or more domain embeddings (w) 222.1 through 222.n each representing a respective entity (ν) 212.1 through 212.n in the target embedding space. The inference system 10 can obtain the set 221 of domain embeddings 222 in a number of ways. For example, the inference system 10 may sample one or more of the domain embeddings 222.1 through 222.n from a probability distribution over the target embedding space, e.g., a uniform distribution or a Gaussian distribution having a mean corresponding to a particular domain embedding (and/or entity) of interest. As another example, the inference system 10 can extrapolate one or more given domain embeddings, e.g., each representing a particular entity of interest, along one or more CAV directions to generate one or more of the domain embeddings 222.1 through 222.n. In these cases, one or more of the entities 212 in the corresponding set 211 of entities 212 may be hypothetical or non-existent, i.e., do not belong to the vocabulary 210, but nonetheless have a representation in the target embedding space. As another example, the inference system 10 can receive the set 221 of domain embeddings 222 from an external source, e.g., in a query provided by a user. As yet another example, if the target embedding model 200 is accessible, the inference system 10 can select (e.g., randomly or according to an algorithm) the set 211 of entities 212 from the vocabulary 210 and then process each entity 212.1 through 212.n, using the entity encoder 220, to generate the respective domain embedding 222 representing the entity 212. The inference system 10 may use these domain embeddings 222 as is or perturb them, e.g., along CAV direction(s) as noted above.

The inference system 10 then receives a text prompt 230 including a sequence 231 of input language tokens 232.1 through 232.m describing, e.g., in a natural language, a particular machine learning task t E [symbol] to be performed on the set 211 of entities 212. In general, a machine learning task can operate on one or more entities as represented by their respective domain embeddings. Examples of move-related tasks that operate on a single movie and pairs of movies are described in the MovieLens experiment sections below.

The inference system 10 prepares an input sequence(s) 102 for the neural network 110. The input sequence 102 includes each input language token 232.1 through 232.m of the text prompt 230 and one or more of the domain embeddings 222.1 through 222.n representing their respective entities 212.1 through 212.n. Note, the inference system 10 may use some or all of the domain embeddings 221.1 through 222.n in the input sequence 102 depending on the particular machine learning task described by the text prompt 230. For example, if the text prompt 230 describes a machine learning task to be performed on a single entity, the inference system 10 can prepare a respective input sequence 102 for each entity 212 that includes the text prompt 230 and the respective domain embedding 222 representing the entity 212. As another example, if the text prompt 230 describes a machine learning task to be performed on multiple entities, the inference system 10 can prepare input sequences 102 that include the text prompt 230 and different combinations of the domain embeddings 222 of the entities 212.

The inference system 10 then processes the input sequence 102, using the neural network 100, to generate a sequence 122 of output language tokens. The output sequence (0) 122 describes, e.g., in the natural language, a result of the particular machine learning task performed on the set 211 of entities 212. The encoder neural network 110 processes the input sequence 102, element-to-element, to generate a sequence 132 of token embeddings representing the input sequence 102 in the token embedding space. Particularly, the token embedding layer(s) 112 process each input language token 232 in the input sequence 102 to generate the respective token embedding representing the input language token 232. The adapter embedding layer(s) 114 process each domain embedding 222 in the input sequence 102 to generate the respective token embedding representing the domain embedding 222. The decoder neural network 120 then processes the token embedding sequence 132, sequence-to-sequence, to generate the output sequence 122 describing the result of the particular machine learning task.

In other words, the output sequence 122 provides a descriptive, language-based narration of the particular machine learning performed on the entities 212 (as represented by their respective domain embeddings 222). This allows a user of the inference system 10 to interpret the target embedding space in a form that is amenable for humans (and can therefore be evaluated for consistency by humans). For example, for a hypothetical entity, the output sequence 122 can describe properties of the hypothetical entity and/or interactions of the hypothetical entity with existing entities in the vocabulary 210, e.g., relations and differences between the hypothetical and existing entities, interpolations between the hypothetical and existing entities, and so on. This has a number of advantages over conventional techniques, e.g., visualization techniques, as the neural network 100 can be prompted to generate an output sequence 122 that describes the particular features of interest. Returning to the example of a hypothetical, unsynthesized ligand. The neural network 100 can be prompted with a text prompt 230 (and the domain embedding of the hypothetical ligand) that asks the neural network 100 to predict the physical properties of the hypothetical ligand and its interaction with a protein of therapeutic interest. The neural network 100 can then generate an output sequence 122 that predicts the chemical formula of the hypothetical ligand, the solubility of the hypothetical ligand, and so on, as well as interaction properties between the hypothetical ligand and the protein, such as the binding free energy between the hypothetical ligand and the protein, the expected pose of the bound state, etc. This allows a user to understand how different points in the target embedding space manifest different features of the entities represented therein.

Note, in practice, the neural network 100 typically generates the output sequence 122 iteratively, i.e., one language token at a time, using an autoregressive sampling procedure. Particularly, for each k-th position in the output sequence 122, the decoder neural network 120 generates a respective probability distribution [symbol] (oₖ|o_{0:k-1}; c), e.g., in the form of logits, over the language token vocabulary. The neural network 100 then samples the output token oₖ˜ [symbol] (oₖ) for the k-th position from the respective probability distribution. In general, the probability distribution is conditioned on the set 221 of domain embeddings c={w₁, . . . , Wₙ} in the input sequence 102, as well as the output token sampled by the neural network 100 at each previous position in the output sequence o_{0:k-1}={o₀, . . . , oₖ₋₁}. To accomplish this, the neural network 100 iteratively appends the output token generated at each position to the input sequence 102, such that Sₖ={s, o_{0:k-1}} is the current input sequence at the k-th position. The neural network 100 then reprocesses the current input sequence (Sₖ), as described above, to generate the probability distribution at the k-th position (and thereafter samples the output token at the position). The neural network 100 does this continuously until an end-of-sentence (EOS) token (o_{N-1}) is reached for, forming the output sequence o=o_{0:N-1}={o₀, . . . , o_{N-1}} with a length of N.

The inference system 10 can be implemented in any appropriate location, e.g., on a user device (e.g., a mobile device), or on one or more computers in a data center, etc. In some implementations, users can interact with the inference system 10, e.g., by providing a query (e.g., including a text prompt 230 or an input sequence 102 for the neural network 100) by way of an interface, e.g., a graphical user interface, or an application programming interface (API). In particular, a user can provide an input that includes: (i) a request to analyze the target embedding space using the neural network 100, and (ii) a query including a text prompt 230 describing a particular machine task in the set to be performed on one or more entities 212. In response to receiving the input, the inference system 10 can generate an input sequence 102 from the text prompt 230 and respective domain embeddings of the entity(s) 212 as described above. The inference system 10 can then process the input sequence 102 using the neural network 100, responsive to the request, and provide the resulting output sequence 122 to the user, e.g., for implementation on a user device of the user, or for storage in a data storage device. In some cases, the inference system 10 can transmit the output sequence 122 to a user device of the user, e.g., by way of a data communication network (e.g., the Internet).

FIG. 1B is an illustration of an example implementation of the inference system 10 for analyzing hypothetical movies in a movie embedding space using the neural network 100. The input sequence 102 includes the textual and domain embedding portions input to the neural network 100. The output sequence 122 includes the textual portion output by the neural network 100 after processing the input sequence 102.

FIG. 1C is a flow diagram of an example process 300 for analyzing a target embedding space using a neural network configured to perform a set of machine learning tasks. For convenience, the process 300 will be described as being performed by a system of one or more computers located in one or more locations. For example, an inference system, e.g., the inference system 10 of FIG. 1A, appropriately programmed in accordance with this specification, can perform the process 300.

The inference system obtains, for each of one or more entities, a respective domain embedding representing the entity in the target embedding space (310).

The inference system receives a text prompt including a sequence of input tokens describing a particular machine learning task in the set to be performed on the one or more entities (320).

The inference system prepares, for the neural network, an input sequence including each input token of the text prompt and each domain embedding representing its respective entity (330).

The inference system processes the input sequence, using the neural network, to generate a sequence of output tokens describing a result of the particular machine learning task (340).

In some implementations of the process 300, the neural network includes an encoder neural network and a decoder neural network. The encoder neural network is configured to receive the input sequence and process the input sequence to generate a sequence of token embeddings representing the input sequence in a token embedding space. The decoder neural network is configured to receive the sequence of token embeddings and process the sequence of token embeddings to generate the sequence output tokens describing the result of the particular machine learning task.

In some implementations of the process 300, the sequence of token embeddings includes, for each input token and domain embedding in the input sequence, a respective token embedding representing the input token or domain embedding in the token embedding space.

In some implementations of the process 300, the neural network includes one or more token embedding layers and one or more adapter embedding layers. The token embedding layer(s) are configured to receive each input token in the input sequence and process the input token to generate the respective token embedding representing the input token in the token embedding space. The adapter embedding layer(s) are configured to receive each domain embedding in the input sequence and process the domain embedding to generate the respective token embedding representing the domain embedding in the token embedding space.

In some implementations of the process 300, the token embedding layer(s) and the decoder neural network are part of a large language model. For example, the large language model can be a decoder-only Transformer model.

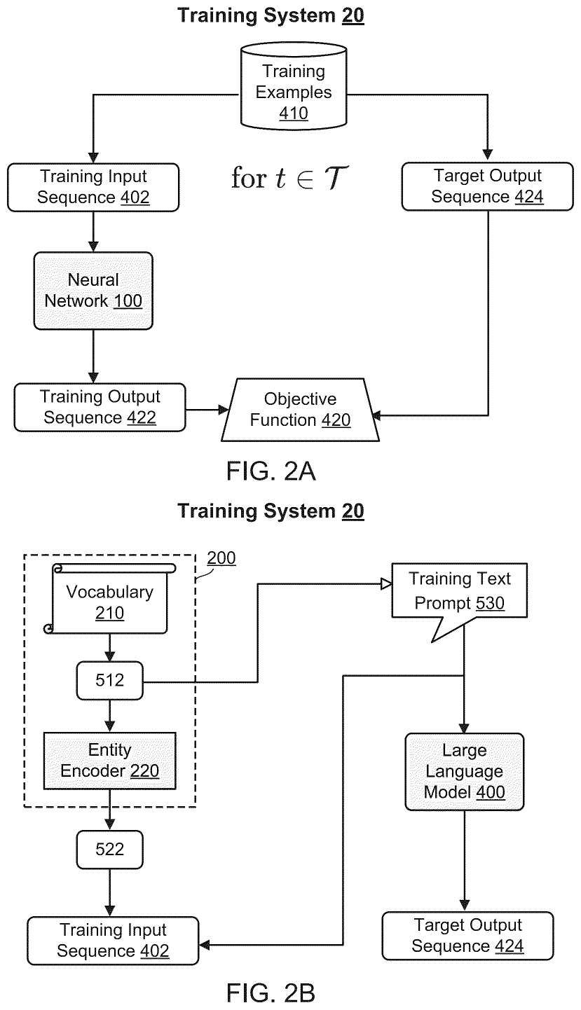

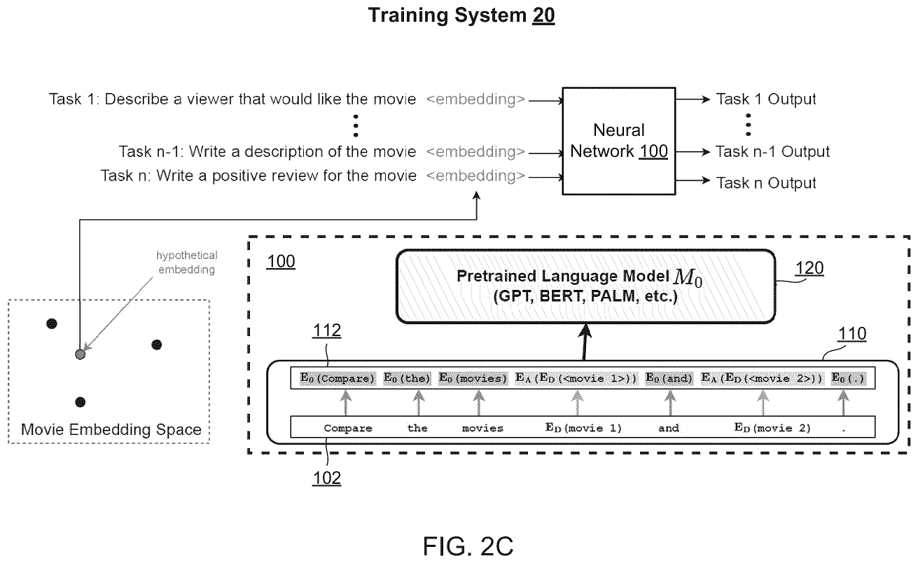

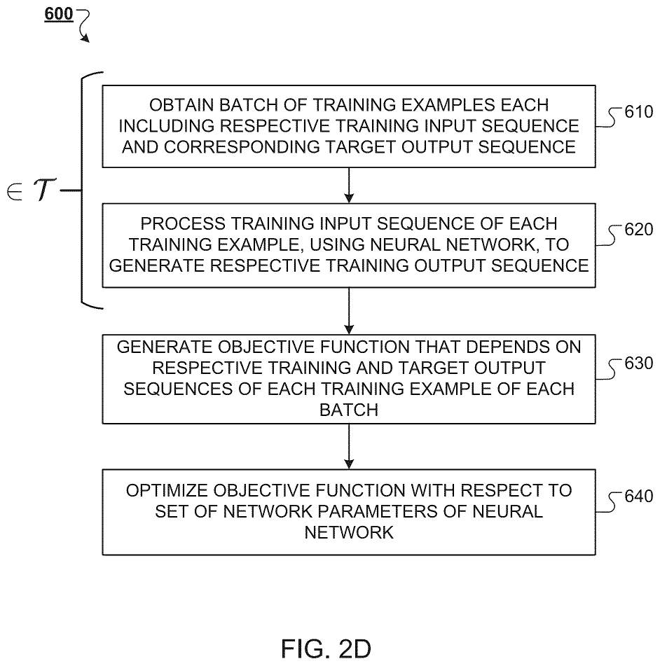

FIG. 2A is a schematic diagram depicting an example of a training system 20 configured to train the neural network 100 to perform the set of machine learning tasks. The training system 20 is an example of a system implemented as computer programs on one or more computers in one or more locations in which the systems, components, and techniques described below are implemented.

For each machine learning task in the set t∈ [symbol] , the training system 20 is configured to train the neural network 100 on a respective batch of training examples 410. Each training example (s, o) in the batch 410 includes: (i) a respective training input sequence(s) 402, and (ii) a corresponding target (e.g., ground-truth) output sequence (o) 424. For example, the training system 20 can draw each training example in the batch of training examples 410 from a probability distribution (s, o)˜ [symbol] over training examples for the machine learning task. The training system 20 may also draw the machine learning task (t) itself from a probability distribution t˜ [symbol] over the set of machine learning tasks.

The training input sequence 402 includes language tokens derived from a training text prompt 530 and one or more domain embeddings 522. The training text prompt 530 describes the machine learning task to be performed on one or more (training) entities 512, and each domain embedding 522 represents one of the training entities 512 in the target embedding space. In some implementations, each training entity 512 belongs to the vocabulary 210, e.g., as ground-truth data can be obtained for such entities. The target output sequence 424 describes a target result of the machine learning task. The target output sequence 424 may be provided (or derived) from input by a user. Alternatively, the training system 20 can generate the sequences 402 and 424 for the training example, e.g., using an LLM 400 as shown in FIG. 2B. The training system 20 processes the training input sequence 402, using the neural network 100, to generate a training output sequence 422 describing an approximate result of the machine learning task.

The training system 20 then generates an objective function (/) 420 that depends on the respective training 422 and target 424 output sequences of each training example of each batch of training examples 410. Then, given a set of network parameters (θ) parametrizing the model [symbol] _{ELM}^{θ} of the neural network 100, the training system 10 can optimize (e.g., minimize) the objection function 420 with respect to the network parameters as:

$${θ}^{*} = arg {min}_{θ} {𝔼}_{( s , o ) ∼ {𝒫}_{t} ; t ∼ {𝒫}_{𝒯}} [ {J}_{θ} ( {ℳ}_{ELM} ( s , o ) ) ] ,$$

where θ* are an optimal set of network parameters for the neural network 100 that optimize the objective function 420. For example, when implementing a stochastic gradient descent method, e.g., Implicit updates, Momentum, AdaGrad, RMSProp, Adam, or the like, the training system 20 can use backpropagation to determine gradients of the objection function 420 with respect to the network parameters of the neural network 100. The training system 20 can then apply an appropriate update rule, e.g., with a particular learning rate and/or weight decay, to update the network parameters using the gradients. In general, the above objective corresponds a maximum likelihood learning algorithm for the neural network 100. However, the training system 20 can also use a reinforcement learning algorithm (e.g., from AI feedback) to train the neural network 100, e.g., fine-tune the neural network 100 after training via a maximum likelihood learning algorithm. This type of training algorithm is described in more detail below.

Note though, training the neural network 100 on continuous textual prompts that include both language tokens and domain embeddings poses challenges due to constraints over the pretrained token embedding layer(s) 112, which may result in convergence to local minima. Intuitively, as the pretrained token embedding layer(s) (E₀) 112 readily map to the token embedding space, the newly initialized adapter embedding layer(s) (E_{A}) 114 may involve numerous updates to map to the same token embedding space. To overcome this, the training system 20 can divide training into two separate stages. In the first stage, the training system 20 trains the adapter embedding layer(s) (E_{A}) 114 on batches of training examples 410 for each of the machine learning tasks in [symbol] while holding the token embedding layer(s) 112 and decoder neural network 120 frozen, i.e., the LLM 130 of the neural network 100. Since the decoder neural network (M₀) 120 is pretrained, the learned first-stage mapping E_{A}: [symbol] improves convergence in the next, second stage. In the second stage, the training system 20 fine-tunes the full, pre-trained model ( [symbol] _{ELM}) of the neural network 100 on the batches of training examples 410 by jointly training each of the token embedding layer(s) 112, adapter embedding layer(s) 114, and decoder neural network 120 models (E₀, E_{A}, M₀). To increase efficiency during the fine-tuning, the training system 20 can update a small number of network parameters of the neural network 100 in alternating fashion, e.g., using LoRA (Low-Rank Adaptation) of large language models. This two-stage training procedure can significantly improve convergence of the neural network ( [symbol] _{ELM}) 100, see Section 1.4 of the Experiments for further discussion of the two-stage training procedure.

FIG. 2B is a schematic diagram depicting an example implementation of the training system 20 generating a training example (s, o) for a machine learning task using a large language model (LLM) 400, e.g., a text-only LLM. For example, the LLM 400 can be the pre-trained LLM 130 of the neural network 100 itself, e.g., including the token embedding layer(s) 112 and the decoder neural network 120, or a different LLM.

As shown in FIG. 2B, the training system 20 selects one or more training entities 512 from the vocabulary 210 of the target embedding model 200. The training system 20 then generates (or otherwise obtains) a training text prompt 530 describing the machine learning task to be performed on the training entity(s) 512, where the training text prompt 530 includes a respect language token for each training entity 512, e.g., the particular word for the training entity 512 in a natural language. The training system 20 processes the training text prompt 530, using the LLM 400, to generate the target output sequence (o) 424 for the training example. The training system 20 then processes each training entity 512, using the entity encoder 220 of the target embedding model 200, to generate a respective domain embedding 522 representing the training entity 512 in the target embedding space. After which, the training system 20 generates the training input sequence(s) 402 for the training example by substituting the respective language token for each training entity 512 in the text prompt 530 with the corresponding domain embedding 522 of the training entity 512. Note, an opposite procedure can also proceed, where the training system 20 substitutes the domain embedding(s) 522 in the training input sequence 402 with the language tokens of the training entities 512 to generate the training text prompt 530.

This above procedure provides an appropriately correlated training example for the machine learning task the neural network 100 is trained to learn. Particularly, this procedure allows the training system 20 to leverage the LLM 400 to generate ground-truth (or close to ground-truth) training data for training the adapter embedding layers(s) 112 to map to the token embedding space. After such training, e.g., including fine-tuning of the neural network 100 as described above, the neural network 100 can then perform the machine learning task on domain embeddings for hypothetical entities, e.g., for which no ground-truth training data exists.

FIG. 2C is an illustration of an example implementation of the training system 20 for training the neural network 100 to perform a set of movie-related machine learning tasks on a movie embedding space, e.g., a target embedding space that encodes movies as entities. After training on ground-truth training data, the neural network 100 can then perform such move-related tasks on hypothetical movies.

FIG. 2D is a flow diagram of an example process 600 for training a neural network to perform a set of machine learning tasks. For convenience, the process 600 will be described as being performed by a system of one or more computers located in one or more locations. For example, a training system, e.g., the training system 20 of FIG. 2A, appropriately programmed in accordance with this specification, can perform the process 600.

For each machine learning task in the set:

The training system obtains a batch of training examples for the machine learning task (610). Each training example in the batch includes: (i) a respective training input sequence, and (ii) a corresponding target output sequence. The training input sequence includes input language tokens of a training text prompt describing the machine learning task to be performed on one or more training entities, and for each training entity, a respective domain embedding representing the training entity in the target embedding space. The target output sequence includes target language tokens describing a target result of the machine learning task performed on the training entity(s).

The training system process the training input sequence of each training example in the batch, using the neural network, to generate a respective training output sequence (620). The training output sequence includes output language tokens describing an approximate result of the machine learning task performed on the training entity(s).

The training system generates an objective function that depends on the respective training and target output sequences of each training example of each batch of training examples (630).

The training system then optimizes the objective function with respect to a set of neural network parameters of the neural network (640). For example, the training system can implement a stochastic gradient descent method, e.g., Implicit updates, Momentum, AdaGrad, RMSProp, Adam, or the like, and use backpropagation to determine gradients of the objection function with respect to the network parameters of the neural network. The training system can then apply an appropriate update rule, e.g., with a particular learning rate and/or weight decay, to update the network parameters using the gradients.

### EXPERIMENTS

### 1.0 Experiment on MovieLens 25M Dataset

This section describes the datasets, tasks, and evaluation methods used to train and validate the neural network 100 described herein in an experiment involving analyzing domain embeddings related to movies. Here, the MovieLens 25M dataset was used and enriched with textual descriptions by generating a large corpus of text using a PaLM 2-L (Unicorn) LLM. The MovieLens 25M dataset contains twenty-five million ratings, in a range from 1 to 5, of 62,423 movies provided by 162, 541 users. Two different forms of domain embeddings were used: (i) behavioral embeddings, and (ii) semantic embeddings, which are described below. Various evaluation techniques were adopted for assessing the quality of the neural network 100's outputs on test data, including qualitative human evaluations and specific consistency metrics.

### 1.1: Data

Domain Embeddings. Domain embeddings were created for both users and movies in the MovieLens dataset. Two types of domain embeddings were considered.

The first type of domain embedding is referred to herein as a “semantic embedding”, which were generated using textual descriptions of movies. Particularly, a pretrained dual-encoder language model (DLM) was used as the entity encoder 220, which has a similar architecture as Sentence-T5 and generalizable T5-based dense retrievers. The plot descriptions and reviews for each movie were concatenated, and these were processed as input by the DLM. The resulting output embedding vectors were then averaged to generate the semantic embedding of the movie. A movie m's semantic embedding is denoted herein as wan. In other implementations, a video encoder could be used to directly encode a movie to the semantic embedding space.

The second type of domain embedding is referred to herein as a “behavioral embedding”, which the neural network 100 was trained to interpret based on user ratings of movies. More generally, the neural network 100 can reflect any behavioral interaction between users and items, but requires no direct semantic information. To train behavioral embeddings, matrix factorization (MF) was implemented and computed via weighted alternating least squares (WALS), such that the dot product \hat{r}= [symbol] wᵤ^{b}, wₘ^{b} [symbol] of the domain embeddings of the user (u) and movie (m) is predictive of user u's rating for movie m. MF was trained using movies that have at least five ratings. Note, other collaborative filtering (CF) methods can also be implemented, e.g., dual encoders, but this approach is agnostic to the precise method used to generate behavioral or semantic embeddings.

Training Data and Tasks. Two versions of the neural network 100 were tested, a first version that interpreted semantic embeddings of movies, and a second version that interpreted behavioral embeddings of users. For the first model, a variety of tasks were used to test the neural network 100's ability to extract reasonable semantic information from the domain embeddings. More specifically, 24 movie-related tasks were constructed using a pretrained PaLM 2-L model. For each task, training data was generated by prompting the PaLM 2-L with a movie's title and additional task-specific information (e.g., writing review, listing characteristics, and comparing movies, see details below). PaLM 2-L's generated output was then used as training targets for the neural network 100. As for training inputs, the neural network 100 was provided with the same text prompts used for PaLM 2-L, where the title of the movie m was replaced by its semantic embedding wₘ^{s}. It is emphasized that the neural network 100 did not receive any information about the movie (including its title) during training, apart from its semantic embedding.

The 24 movie tasks included: single movie semantic tasks, such as describing a movie plot or summarizing a movie; single movie subjective tasks, such as writing positive or negative reviews for a movie; and movie pair subjective tasks, such as comparing characteristics of movies. Section 1.4 provides a complete description of all 24 tasks, including the prompts used, and sample outputs.

The second version of the neural network 100 was trained to interpret behavioral embeddings of users, by generating user preference profiles. For this task, a textual summary of a user's preferences was generated as follows: (a) sampling five positively rated and five negatively rated movies for each user in MovieLens 25M; and (b) prompting PaLM 2-L to describe (in ten bullet points) characteristics of a person who likes the first five movies, but dislikes the second five. This resulting summary was used as training output for the neural network 100 on the user-profile generation task. The resulting task was to generate such a user profile from a user's behavioral embedding wᵤ^{b}(i.e., interpret the domain embedding). Similar to the movie tasks, no other information about the user, apart from its behavioral embedding, was provided to the neural network 100. Refer to Section 1.4 for more details and examples.

### 1.2 Evaluation Metrics

Several forms of evaluation were employed for assessing the neural network 100. First, given the inherent subjectivity of some tasks (e.g., movie reviews), human-raters played a key role in gauging output quality. The raters were asked to assess the neural network 100's output with respect to its consistency with a movie's plot, its linguistic coherence, and overall task quality. Each output was rated on a scale from 0 (completely irrelevant/incoherent) to 1 (highly relevant/coherent). The average rater's score provided a holistic assessment of the neural network 100's performance. Second, the goal was interpretation of target embeddings spaces and the generation of descriptions of domain embeddings for which no entity existed in the vocabulary 210 (e.g., hypothetical movies). Hence, the consistency of the neural network 100's output text was evaluated against the domain embedding and the ground-truth data used to train the neural network 100 on the domain embedding. To achieve this, two consistency metrics were introduced, namely, “semantic consistency” and “behavioral consistency”, which are described below.

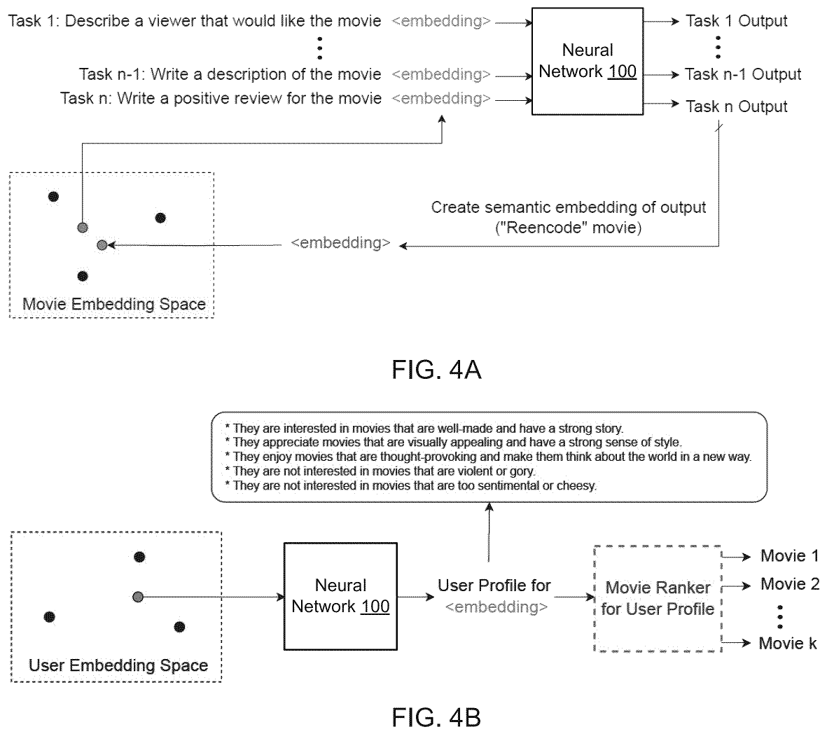

Semantic consistency (SC) compares a semantic embedding of generated text with the original semantic embedding that produced said text. For the movie tasks, this metric was computed by re-embedding the neural network 100's output text into the same target embedding space that was used to embed the original movies. Formally, the semantic consistency of an output sequence (o) generated by the neural network 100 in response to a semantic embedding w^{s} ∈ [symbol] is defined as:

$$SC ( o , {w}^{s} ) = d [ P ( o ) , {w}^{s} ] ,$$

where P(o) is a projection function, e.g., an encoder neural network, that projects the output sequence (o) to the target embedding space ( [symbol] ) and d is the distance metric in [symbol] (or alternatively, a similarity measure). See Section 1.4 and FIG. 4A for an illustration. As shown in FIG. 4A, the output for a task is “re-encoded” back to the semantic embedding space. The distance metric is then used to capture the consistency to the original semantic embedding that generated the output. In the experiments, the same DLM serving as the entity encoder 220 for the movies was used as the projector P, i.e., to re-embed output text from the neural network 100 into the same semantic embedding space. The utility of SC is grounded in the expectation that if the generated output o holds true to its source w^{s}, then its embedded representation should not deviate substantially from its generating semantic embedding. Hence, a high SC suggests that the neural network 100 has well-aligned domain embeddings with their task-specific descriptions. Notably, this approach is not tied to examples in training data, providing the flexibility to measure the semantic consistency of hypothetical entities (as well as implement reinforcement learning techniques as described below).

Behavioral consistency (BC) measures the ability to use the neural network 100's output text to make good behavioral predictions. For example, in a user-profile task, the neural network 100's ability to generate user profiles was tested to predict the movie preferences of a user corresponding to the input behavioral embedding. This in turn suggested the extent to which the user profile captured the information implicit in that domain embedding (i.e., the latent user preferences).

To achieve this, the BC can be formulated using an “off-the-shelf” language-based retriever/ranker (p) which, given a user profile, is configured to rank a set of candidate movies (or generic items). Then, given a fixed set of target movies, [symbol] , and letting oᵤ be the user profile generated by the neural network 100 given the domain embedding w″, the BC is defined as:

$$BC ( o , {w}_{u}^{b} ) = BC ( {o}_{u} , u ) = RankingScore [ {R}_{u} , ρ ( {o}_{u} ) ] ,$$

where p (oᵤ) are the ranks of the movies in J for user u provided by the language-based ranker, and Rᵤ={r(u,m):m ∈ [symbol] } are the MovieLens ground-truth ratings for [symbol] provided by the user (u), converted to rankings. See Section 1.4 and FIG. 4B for an illustration. As shown in FIG. 4B, a user profile generated by the neural network 100 was input to a Movie Ranker (p), which ranks movies based on the user profile. The ranks of the movies were then compared to their ground-truth ranks in the MovieLens data using a suitable RankingScore function, which were carried by the behavioral embedding that was used to generate the user profile. In the experiments, the DLM serving as the entity encoder 220 was also used as the language-based ranker (p), e.g., by embedding test movies and user profiles and using their similarity for scoring/ranking. Here, RankingScore is any rank-comparison metric which compares p(oᵤ) to the ground-truth ranking R. Examples include, but are not limited to, discounted cumulative gain (DCG), normalized discounted cumulative gain (NDCG), and the Spearman rank-correlation coefficient. The behavioral consistency of the movies was measured in a fully analogous fashion (see Section 1.4 for a formal definition).

### 1.3 Empirical Analysis

The neural network 100 was evaluated on the 24 movie tasks and the user profile task, described above in Section 1.2, using human-raters and semantic and behavioral consistency to measure performance. Test results were analyzed on both real entities (i.e., held-out movies) and hypothetical domain embeddings not in the data, to test the neural network 100's ability to interpolate between movies or users, as well as extrapolate movie or user attributes.

Two models of the neural network 100 were trained: one (joint) model for the 24 movie tasks, and another for user profiles. For the movie tasks, 1,000 randomly sampled examples were used for testing and the rest for training. For the user profile task, an 80/20 training/test split was used. Both models were fine-tuned using a pretrained PaLM 2-XS (Otter). A two-layer MLP was used for the domain-embedding adapter layers (E_{A}), and a two-stage training procedure, as described above. Particularly, for movie tasks, the first stage of training was run for 20,000 iterations, and then the second stage for another 300,000 iterations, using a batch size of 32 (i.e., roughly seven epochs). A similar procedure was employed for user profiles. It was found that training in two stages significantly improved convergence of the neural network 100, see Section 1.4 for further details.

Test-item Evaluation. Table 1 below shows consistency (SC and BC) and human-rater results for all movie tasks on the test set. For each task, 100 human-raters were asked to rate the consistency and comprehensiveness of the neural network 100's results against the ground-truth data. Raters were paid contractors. They received their standard contracted wage, which is above the living wage in their country of employment. Qualitative task-specific questions were also asked, see Section 1.4 which describes human-rater instructions in detail. Rater evaluations show that the neural network 100 was able to generalize across most tasks. Moreover, the neural network 100 maintained high semantic consistency across all tasks and good behavioral consistency for most. The performance tended to be worse on two-movie tasks, due to the additional challenge of “conversing” about similarities and differences between two distinct domain embedding representations. The consistency metrics are noteworthy, as they reflect how well the neural network 100 adapted to the target embedding space ( [symbol] ).

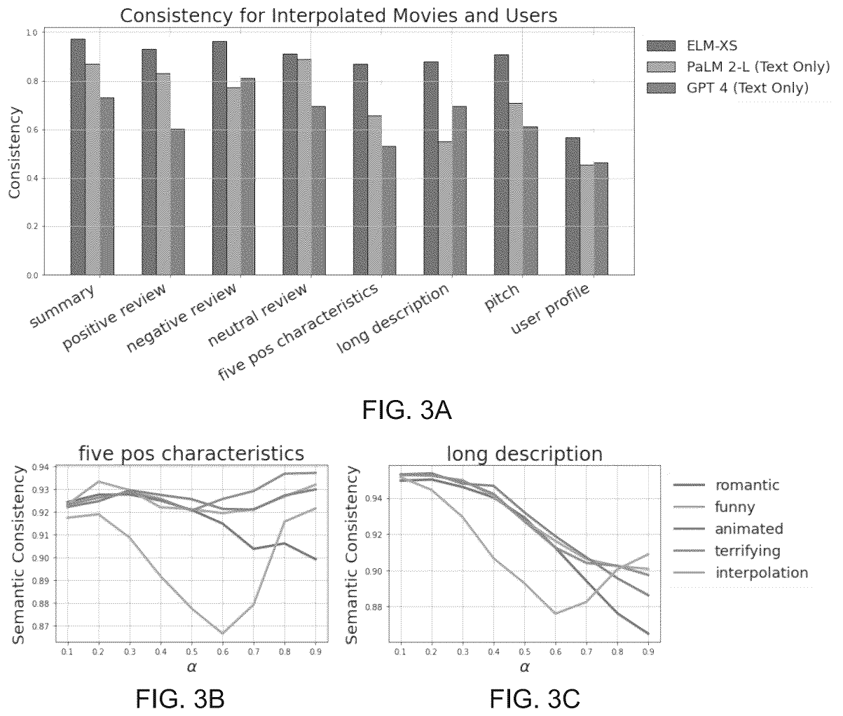

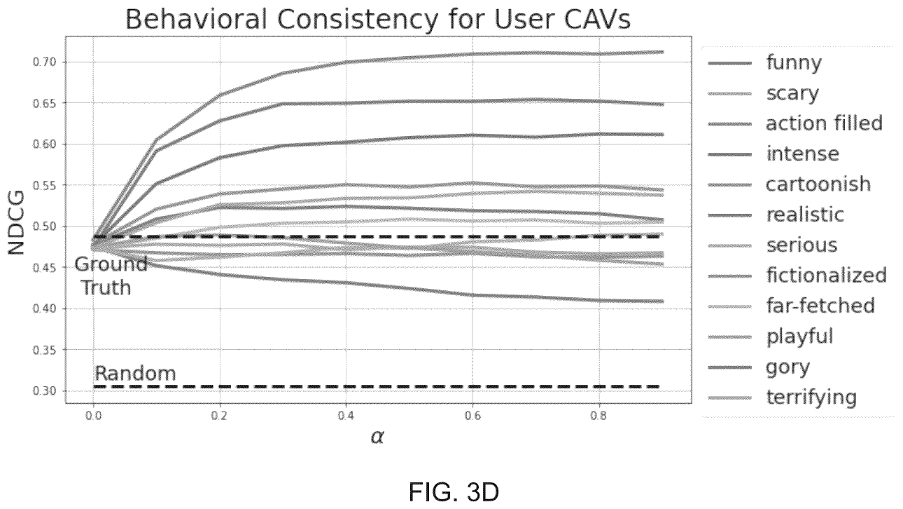

TABLE 1
Test Scores for 24 movie tasks. Cosine similarity was used for semantic
consistency (SC), and Spearman rank-correlation coefficient for
behavior consistency (BC). For human evaluation, normalized scores
between 0 (strongly disagree) and 1 (strongly agree) are provided.
Table 1 is divided into two sections: single movie tasks and two
movie tasks. Tasks with “nn” abbreviation use nearest neighbor
movies in semantic embedding space. A comparison of semantic and
behavioral consistency metrics is demonstrated in FIGS. 3A-3D.

| | Consistency Metrics | | | | |
|---|---|---|---|---|---|
| | | Behav- | Human Evaluation (100 raters) | | |
| | | ioral | Consis- | Language | |
| | Semantic | (Rank | tency | Comprehen- | Task |
| Task | (Cosine) | Corr.) | w/ Plot | siveness | Quality |
| summary | 0.91 | 0.94 | 0.87 | 0.87 | 0.85 |
| positive review | 0.94 | 0.81 | 0.90 | 0.90 | 0.89 |
| negative review | 0.93 | 0.79 | 0.93 | 0.96 | 0.96 |
| neutral review | 0.92 | 0.76 | 1.00 | 1.00 | 0.56 |
| five pos char. | 0.91 | 0.80 | 0.84 | 0.92 | 0.95 |
| five neg. char. | 0.89 | 0.80 | 0.81 | 0.92 | 0.89 |
| long description | 0.91 | 0.80 | 0.89 | 0.86 | 0.89 |
| funnier | 0.88 | 0.81 | 0.75 | 0.78 | 0.68 |
| sadder | 0.91 | 0.82 | 0.59 | 0.83 | 0.81 |
| scarier | 0.90 | 0.84 | 0.69 | 0.74 | 0.95 |
| improve | 0.91 | 0.82 | 0.85 | 0.89 | 0.87 |
| movie to viewer | 0.89 | 0.80 | 0.89 | 0.83 | 0.86 |
| pitch | 0.96 | 0.80 | 0.96 | 0.50 | 0.94 |
| criticize | 0.89 | 0.77 | 0.88 | 0.70 | 0.79 |
| convince1 | 0.92 | 0.96 | 0.98 | 0.93 | 0.77 |
| convince2 | 0.90 | 0.88 | 0.89 | 0.86 | 0.87 |
| convince3 | 0.88 | 0.86 | 0.70 | 0.67 | 0.74 |
| dissuade1 | 0.88 | 0.85 | 0.88 | 0.89 | 0.87 |
| dissuade2 | 0.88 | 0.87 | 0.79 | 0.8 | 0.79 |
| similarities | 0.86 | 0.83 | 0.37 | 0.40 | 0.38 |
| interpolation | 0.89 | 0.80 | 0.85 | 0.82 | 0.84 |
| why like nn | 0.83 | 0.48 | 0.84 | 0.84 | 0.91 |
| diff than nn | 0.82 | 0.48 | 0.61 | 0.79 | 0.64 |
| common with nn | 0.77 | 0.46 | 0.91 | 0.86 | 0.94 |

Communicating Novel Entities. The neural network 100's capability to meaningfully extrapolate from existing movies or users to interpret “gaps” in embedding space was also tested, e.g., embedding vectors of hypothetical movies for which the neural network 100 predicts a large audience. Note that such hypothetical domain embeddings have no ground-truth data for evaluation; nor is it clear how to evaluate hypothetical embeddings using text-only LLMs. For instance, there is no obvious way to instruct a text-only LLM to describe an arbitrary domain embedding in the target embedding space (W). Even if a text-only LLM was queried to interpolate two existing entities (e.g., movies), the result would not necessarily be consistent with the target embedding space, nor can one in general direct a text-only LLM to an arbitrary point using interpolation between a small number of existing entities. Behavioral embeddings of, say, users are even more challenging for LLMs. This puts additional emphasis on the need to evaluate such LLMs using embedding consistency metrics like SC and BC. That said, to ground the results, arbitrary hypothetical points in embedding space were not considered. Instead, the neural network 100 was evaluated using interpolation of existing entities, as well shifts of such entities in specific directions (see Generalizing CAVs below). Nevertheless, the neural network 100's ability to interpret hypothetical domain embeddings is not constrained to these choices.

First, consistency metrics were assessed on interpolations of two movies or users. FIG. 3A compares the performance of the neural network 100 with state-of-the-art text-only LLMs; namely, PaLM 2-L and GPT 4. FIG. 3A shows consistency results for movie and user interpolations using the neural network 100, compared to one-shot decoded results of text-only LLMs. Semantic consistency (cosine similarity) scores are provided for movie tasks and behavioral consistency (NDCG) scores are provided for user profiles. For movies, domain embeddings of movies in the training set were linearly interpolated with the classic movie “Forrest Gump (1994)” (with mixture coefficient α=0.5), and the interpolated doming embedding was provided to the neural network 100. For users, random pairs of user embeddings were interpolated from the training set. For a fairer comparison, the text-only LLMs were provided with ground-truth examples of each task's output, and were prompted to generate the task output. Particularly for users, the text-only LLMs were provided with ground-truth user profiles, and instructed to interpolate between them (see Section 1.4 for the precise prompts used). The semantic consistency was measured for movie tasks and behavioral consistency was measured for the user profile task. It was found that text-only LLMs are significantly less consistent than the neural network 100. This is not surprising, as describing an embedding space manifold to a text-only LLM is especially challenging. Moreover, the neural network 100 was able to generate high-quality, consistent responses to the tasks. Further qualitative results are provided in Section 1.4.

Next, the neural network 100's consistency was tested as the degree of interpolation between movies was varied, by varying the mixture weight parameter a. FIGS. 3B and 3C shows semantic consistency (magenta line) for two of the movie tasks. It was found that outputs were highly consistent across all degrees of interpolation values, with a tendency for lower consistency scores for embeddings that are farther away from the two movies. This result is unsurprising, as performance of the neural network 100 was expected to degrade as it moves away from “real” data points. Also note, these were linear interpolations, though the true embedding manifold may be highly non-linear.

Generalizing Concept Activation Vectors (CAVs). Finally, the interpretation of domain embeddings in the target embedding space were tested by extrapolating existing entity embeddings in specific directions. To accomplish this, CAVs were trained using attribute tags in MovieLens 25M, provided by movie raters. The CAVs were trained using the procedure of Göpfert, Christina, et al., “Discovering Personalized Semantics for Soft Attributes in Recommender Systems Using Concept Activation Vectors,” ACM Transactions on Recommender Systems 2.4 (2024): 1-37, and the dataset of Balog, Krisztian, Filip Radlinski, and Alexandros Karatzoglou, “On Interpretation and Measurement of Soft Attributes for Recommendation,” Proceedings of the 44th International ACM SIGIR Conference on Research and Development in Information Retrieval (2021), both of which are incorporated by reference herein in their entirety for details. Specifically, linear (objective) rather than non-linear and/or subjective CAVs were used. These CAVs can be treated as noisy, “soft” movie attributes, such as ‘funny,’ ‘terrifying,’ ‘thought-provoking,’ etc. The CAV corresponding to a specific attribute provides a direction in the target embedding space that represents an increase in that attribute's value. These CAVs were then used to extrapolate movies and users in specific CAV directions (e.g., make an existing movie funnier, or tweak a user profile to prefer more cartoonish movies).

FIGS. 3B and 3D plot SC scores (using cosine similarity) for interpolations of movies with the movie “Forrest Gump”, as well as extrapolation of CAV attributes in the semantic embedding space. FIG. 3B plots SC scores for the five positive characteristics task while FIG. 3D plots SC scores for the long description task versus the mixture weight parameter a. As show in FIGS. 3B and 3C, semantic consistency of movie extrapolations generally decreased as a increased, corresponding to increased extrapolations in CAV directions. This is expected as extrapolations outside the data manifold should induce higher error.

Similarly, FIG. 3D shows behavioral consistency (BC) results for CAV extrapolations of user profiles. FIG. 3D plots BC scores (using NDCG with the predicted CF model ratings) for user profile decoded outputs, where user embeddings were extrapolated in different CAV directions. Dotted lines show two baselines (for a=0): the random baseline, which rated movies randomly, and the ground-truth baseline, which used the ground-truth user profile data to compute BC (i.e., BC of the ground-truth training data). These results show attribute extrapolations to be behaviorally consistent for different a values. Perhaps surprisingly, user profiles showed greater behavior consistency the degree to which they move in a CAV direction was increased. This may have been due to user profiles becoming “more predictable” in the implemented CF model by making user preferences more extreme. For instance, as a user profile gravitated to funnier movies, preferences tended to degenerate with a near-exclusive focus on funny movies (thus rendering rating prediction—and especially relative rating prediction—more accurate). This in turn increased BC. Further qualitative results for interpolations and CAV-based extrapolations are provided FIG. 1B. Refer to Section 1.4 for more qualitative results.

### 1.4 Further Details of the Experiment

Implementation Details of Semantic and Behavioral Consistency. While human-raters can assess any semantic difference between the ground-truth text and the generated output, semantic consistency can be measured by computing cosine similarity between the semantic embedding of the ground-truth text and the semantic embedding of generated output. For movie tasks, it is more straightforward as the input embedding to the neural network 100 was indeed the semantic embedding of the ground-truth text and the same DLM was also employed to reencode generated outputs by the neural network 100 as shown in FIG. 4A. For the user profile task, the input embedding was a behavioral one though both the input embedding and the ground-truth user profile came from the same user. FIG. 4B describes how the behavioral consistency was defined for users. The input behavioral embedding was predictive of movie rankings, and it was desired to see if the movie ranker gave consistent rankings for randomly selected movies. Zero-star was imputed if a selected movie had no rating. The movie ranker ranked movies based on similarity to the generated user profile in the semantic embedding space defined by the DLM.

Behavioral Consistency for Movies. Similar to behavioral consistency for users, as defined in Section 1.2, the behavioral consistency for movies can also be defined. Letting [symbol] denote a set of users, for any movie task with generated output oₘ of movie m with behavior embedding wₘ^{b}, the behavioral consistency is defined as:

$$BC ( o ; {w}_{m}^{b} ) = BC ( {o}_{m} , m ; 𝒰 ) = RankingScore [ {R}_{m} ‖ ρ ( {o}_{m} ) ]$$

where p(oₘ) are the ranks of the users in [symbol] for movie m, provided by a User Ranker which uses oₘ as its query, and Rₘ={r (u,m): u ∈ [symbol] } are the MovieLens ground-truth ratings for users [symbol] and movie m.

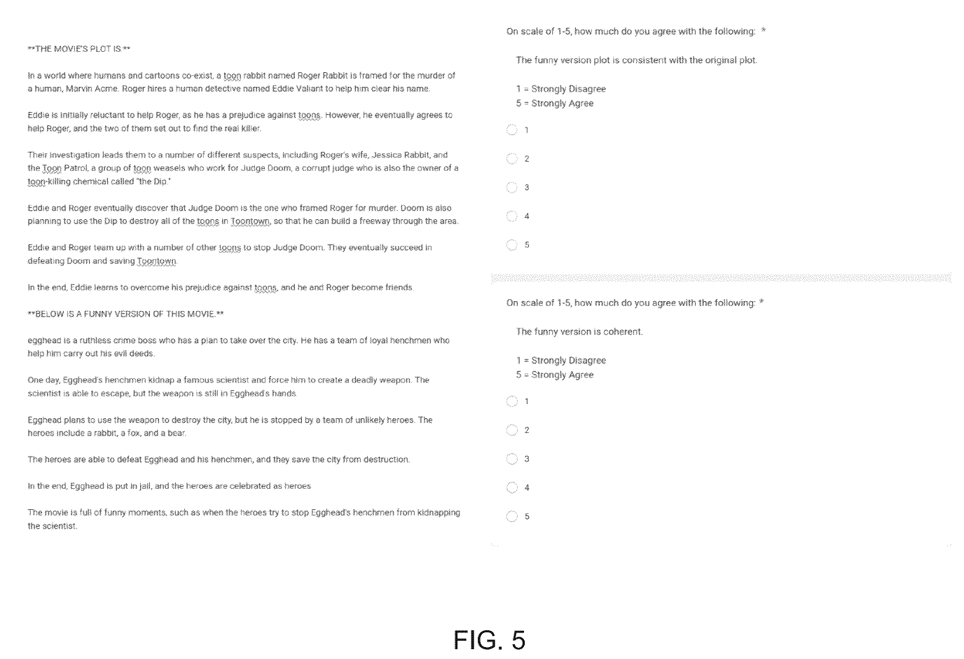

Rater Evaluation. 100 human-raters were asked to evaluate quality of all 24 movie tasks, in terms of consistency with plot, language comprehensiveness, and task quality. For each task, 40 model utterances were generated from the neural network 100 with movies not used in training. Each utterance was saved along with the contexts and questions on a Google form, and a rater was asked to evaluate. FIG. 5 shows an example of the Google Form used as the evaluation Template for running the human-rater experiment for the “funnier” Task. Usually the ground-truth data of a movie was provided first, then the model utterance generated for the task. For questions, the human-raters were asked how much do they agree with the following statement. Below lists questions asked for each task.

1. long description
The second version plot is consistent with the first version.
The second version plot is coherent.
The second version plot is high quality like the first version.

2. summary
The movie summary is consistent with the movie plot.
The movie summary is coherent.
The movie summary is of high quality.

3. positive review
The movie review is consistent with the movie plot.
The movie review is coherent.
The movie review is positive.

4. negative review
The movie review is consistent with the movie plot.
The movie review is coherent.
The movie review is negative.

5. neutral review
The movie review is consistent with the movie plot.
The movie review is coherent.
The movie review is neutral.

6. five pos characteristics
The characteristics listed are consistent with the movie plot.
The characteristics listed are coherent.
The characteristics listed are positive.

7. five neg characteristics.
The characteristics listed are consistent with the movie plot.
The characteristics listed are coherent.
The characteristics listed are negative.

8. improve
The improved version plot is consistent with the original plot.
The improved version is coherent.
Some viewers may find the improved version to be better than the original.

9. criticize
The criticism is consistent with the movie's plot.
The criticism is coherent.
The criticism is of good quality.

10. pitch
The pitch for the movie is consistent with the movie's plot.
The pitch for the movie is coherent.
The pitch is convincing.

11. convince1
The paragraph convincing to watch the movie is consistent with the movie's plot.
The paragraph convincing to watch the movie is coherent.
The paragraph convincing to watch the movie is indeed convincing.
The paragraph convincing to watch the movie is comprehensive.
The paragraph convincing to watch the movie is short and to the point.

12. convince2
The paragraph convincing to watch the movie is consistent with the movie's plot.
The paragraph convincing to watch the movie is coherent.
The paragraph convincing to watch the movie is indeed convincing.
The paragraph convincing to watch the movie is comprehensive.
The paragraph convincing to watch the movie is short and to the point.

13. convince3
The paragraph convincing to watch the movie is consistent with the movie's plot.
The paragraph convincing to watch the movie is coherent.
The paragraph convincing to watch the movie is indeed convincing.
The paragraph convincing to watch the movie is comprehensive.
The paragraph convincing to watch the movie is short and to the point.

14. dissuade1
The paragraph dissuading to watch the movie is consistent with the movie's plot.
The paragraph dissuading to watch the movie is coherent.
The paragraph dissuading to watch the movie is indeed dissuading.
The paragraph dissuading to watch the movie is comprehensive.
The paragraph dissuading to watch the movie is short and to the point.

15. dissuade2
The paragraph dissuading to watch the movie is consistent with the movie's plot.
The paragraph dissuading to watch the movie is coherent.
The paragraph dissuading to watch the movie is indeed dissuading.
The paragraph dissuading to watch the movie is comprehensive.
The paragraph dissuading to watch the movie is short and to the point.

16. funnier
The funny version plot is consistent with the original plot.
The funny version is coherent.
The funny version is indeed funnier than the original.

17. sadder
The sad version plot is consistent with the original plot.
The sad version is coherent.
The sad version is indeed sadder than the original.

18. scarier
The scary version plot is consistent with the original plot.
The scary version is coherent.
The scary version is indeed scarier than the original.

19. movie to viewer.
The viewer description is consistent with the movie's plot.
The viewer's description is coherent.
The viewer will like to watch the movie based on the information above.

20. interpolation
The combination of the movies is consistent with the movies' plots.
The combination of the movies is coherent.
The combination of the movies is high quality, i.e., it combines the movies' plots in a reasonable way.

21. similarities
The comparison is consistent with both movies' plots.
The comparison is coherent.
The comparison of the two movies compares important factors between the movies, both in terms of similarity, as well as differences.

22. why like nn
The explanation is consistent with the movies' plots.
The explanation is coherent.
The explanation indeed explains well why the viewer would also like the other movie.

23. diff than nn
The explanation is consistent with the movies' plots.
The explanation is coherent.
The attributes that are listed are high quality (i.e., they are major and important differentiating attributes of the movies).

24. common with nn
The listed attributes are consistent with both movies' plots.
The listed attributes are coherent.
The attributes that are listed are high quality (i.e., they are major and important common attributes between the movies).

Discussion on Two-Stage Training. In this section an empirical investigation of the two-stage training procedure used to train the neural network 100 is described. Particularly, it was found the two-stage training procedure (as described above) significantly improved convergence of the neural network 100. To demonstrate this, a toy task of decoding a two-dimensional embedding to texts was created. In the training data, samples of mapping embedding [1.0, 0.0] to one and samples of mapping embedding [0.0, 1.0] to two were replicated. The test data had the same content. For this task, no textual prompt was used, but rather trained the neural network 100 to learn to map the 2-dimensional embedding, to either the token corresponding to one, or that corresponding to two.

While this task is seemingly trivial, it was found that training the neural network 100 on a pre-trained model without two-stage training could not fit to the training data. Particularly, fine-tuning the full model of the neural network 100 for over 100,000 iterations always converged to outputting either one or two. When the two-stage training was applied, i.e., first fitting E_{A} and only then the rest of the neural network 100, it was found that the neural network 100 to converged in less than 1,000 iterations. This emphasizes the importance of two-stage training with pre-trained LLMs. It further suggests that training adapter embedding layers to pre-trained LLMs may involve a stage of fitting to the semantic language space.

TABLE 2
A short description of each of the movie tasks.

| Task | Description |
|---|---|
| summary | One paragraph summarizing of movie plot |
| positive review | A positive review of the movie. |
| negative review | A negative review of the movie. |
| neutral review | A neutral review of the movie. |
| five pos char. | Listing five positive characteristics of the movie. |
| five neg. char. | Listing five negative characteristics of the movie. |
| long description | A long exhaustive description of the movie plot. |
| funnier | A plot for a funnier version of the movie. |
| sadder | A plot for a sadder version of the movie. |
| scarier | A plot for a scarier version of the movie. |
| improve | An improved version of the movie |
| | (as generated by an LLM). |
| movie to viewer | Describing a viewer that would like to watch |
| | this movie, including characteristics. |
| pitch | A pitch for the movie. |
| criticize | Criticizing the movie. |
| convince1 | Convincing to watch the movie. |
| convince2 | Convincing in detail to watch the movie. |
| convince3 | Convincing briefly to watch the movie. |
| dissuade1 | Dissuading to watch the movie (version 1 prompt). |
| dissuade2 | Dissuading in detail to watch the movie. |
| similarities | List three similarities between the movies. |
| interpolation | Interpolate the plots of two movies. |
| why like nn | Explain why someone would like a |
| | nearest neighbor movie. |
| diff than nn | Three major differences between two |
| | nearest neighbor movies. |
| common with nn | Three similarities between two |
| | nearest neighbor movies. |

Data Generation Prompts and Sample Training Data. In the following, for each task, the prompt used in training data generation and one sample output from the PaLM 2-L (Unicorn) language model queried with the prompt is listed.

In training these 24 movie-focused tasks, the movie titles were replaced with the movies' respective domain embeddings in the text prompts, i.e., no information about the movie except its domain embedding was provided during training. For example, for task 1, the training input for the model was given by: “<movie embedding>.”, where <movie embedding> was replaced by the semantic embedding of the movie and the model did not have to be prompted with “Do not use the movie's name in your response.” during training. For tasks including two movies not all pairs were enumerated. Instead, for tasks 20-22 random movie comparisons were used, and in tasks 23-24 nearest neighbor comparisons were used. This choice allowed an inductive bias of the target embedding space ( [symbol] ) manifold to be incorporated into the training procedure. In training the user profile task, those five positively rated and five negatively rated movies were replaced with user behavioral embeddings in prompts.

### 1. Long Description

Prompt: Write a long description of the plot of the movie The Derby Stallion (2005). Do not use the movie's name in your response.

Sample Output: The movie is about a young man named Patrick McCardle who has always dreamed of owning and racing a champion thoroughbred horse. He works hard to save up money to buy a horse, and eventually he is able to purchase a colt that he names Soaring Eagle. Patrick and Soaring Eagle train hard together, and they eventually qualify for the Kentucky Derby. The movie follows Patrick and Soaring Eagle as they compete against some of the best horses in the world in the most prestigious race in America. The movie is full of excitement, suspense, and drama, and it is a great story about a young man who achieves his dream.

### 2. Summary

Prompt: Write a long summary of the movie The Shoe (1998). Do not use the movie's name in your answer.

Sample Output: The film is about a young man who is released from prison and tries to adjust to life on the outside. He gets a job at a shoe store and starts to fall for one of his co-workers. However, he is still haunted by his past and struggles to find his place in the world. The film begins with the young man, who is unnamed, being released from prison. He is given a bus ticket and a small amount of money, and he is told to report to his parole officer within 24 hours. The young man is apprehensive about his release, but he is also excited to start a new life. The young man arrives in a small town and finds a room to rent. He then goes to the shoe store where he has been hired to work. The store is owned by a kind and generous man who is willing to give the young man a second chance. The young man also meets his co-workers, who are all friendly and welcoming. The young man starts to adjust to his new life. He enjoys his job and he starts to make friends. He also starts to fall for one of his co-workers, a young woman named Sarah. However, the young man is still haunted by his past. He has nightmares about his time in prison, and he is afraid that he will never be able to fully adjust to life on the outside. One day, the young man is confronted by a group of men from his past. They threaten him and tell him that he must leave town. The young man is scared, but he refuses to back down. He knows that he has to face his past in order to move on with his life. The young man meets with his parole officer, who tells him that he is doing well. The parole officer also tells the young man that he has a visitor. The visitor is the young man's father, who has come to see him for the first time in many years. The young man is surprised and happy to see his father. The two of them talk and they start to rebuild their relationship. The young man is finally able to put his past behind him. He is no longer afraid of his nightmares, and he is no longer afraid of the men who threatened him. He is able to move on with his life and he is able to find happiness.

### 3. Positive Review

Prompt: Write a long positive review for the movie Halloweentown High (2004). Do not use the movie's name in your answer.

Sample Output: The movie is about a young witch who goes to a high school in the human world. The witch has to hide her powers from the other students, and she also has to deal with the prejudice of the humans against witches. The movie is well-made, and it has a lot of heart. The characters are well-developed, and the story is engaging. The movie is a great example of a family-friendly Halloween movie. It is not too scary, but it is still entertaining. The movie is also a great way to teach children about tolerance and acceptance. Overall, the movie is a great choice for a family movie night.

### 4. Negative Review

Prompt: Write a long negative review for the movie Mayerling (1936). Do not use the movie's name in your answer.

Sample Output: This movie is a complete and utter mess. The plot is all over the place, the characters are unlikable and unrelatable, and the acting is just plain bad. The only saving grace is the cinematography, which is admittedly quite beautiful. But even that can't save this movie from being a total bore. The story is about a young prince who falls in love with a commoner. The prince's family disapproves of the match, and the two lovers are forced to part ways. The prince is then sent to a military academy, where he meets another young woman. The two of them fall in love, and the prince eventually marries her. However, he is still in love with the commoner, and the two of them continue to see each other in secret. Eventually, the prince's wife finds out about the affair, and she confronts him. The prince is then forced to choose between his wife and his mistress. The plot is so convoluted and full of holes that it's hard to follow. The characters are all unlikable and unrelatable. The prince is a whiny brat who can't seem to make up his mind about what he wants. His wife is a shrew who is constantly nagging him. And the mistress is a manipulative schemer who is only interested in the prince's money. The acting is just plain bad. The prince is played by an actor who is clearly too old for the role. His wife is played by an actress who is so over-the-top that she's almost comical. And the mistress is played by an actress who is so wooden that she could be mistaken for a piece of furniture. The only saving grace is the cinematography, which is admittedly quite beautiful. The movie is set in some stunning locations, and the director does a good job of capturing the beauty of the scenery. However, even that can't save this movie from being a total bore. Overall, this movie is a complete and utter mess. It's poorly written, poorly acted, and poorly directed. The only thing it has going for it is the cinematography, which is admittedly quite beautiful. But even that can't save this movie from being a total bore.

### 5. Neutral Review

Prompt: Write a long neutral review for the movie Man Hunt (1941). Do not use the movie's name in your answer.

Sample Output: This movie is a thriller about a man who is hired to assassinate a high-ranking Nazi official. The man is successful in his mission, but he is then captured by the Nazis and tortured. He eventually escapes and makes his way back to England, where he is reunited with his wife. The movie is well-made and suspenseful. The acting is good, and the story is interesting. The movie does have some flaws, however. The pacing can be slow at times, and the ending is a bit too neat and tidy. Overall, this is a good movie that is worth watching. It is a suspenseful thriller with good acting and an interesting story.

### 6. Five Pos Characteristics

Prompt: List 5 characteristics of the movie The Very Thought of You (1944) that make it great. Do not use the movie's name in your answer.

Sample Output: 1. The movie is a heartwarming story about two people who find love in the most unexpected of places. 2. The characters are well-developed and relatable, and the acting is top-notch. 3. The cinematography is beautiful, and the soundtrack is perfectly suited to the film's tone. 4. The movie is well-paced and flows smoothly from scene to scene. 5. The overall message of the movie is one of hope and love, which is sure to leave viewers feeling uplifted.

### 7. Five Neg Characteristics

Prompt: List 5 characteristics of the movie 3 Idiots (2009) that people hate about. Do not use the movie's name in your answer.

Sample Output: 1. The movie is too long and slow-paced. 2. The characters are not relatable and are often annoying. 3. The plot is predictable and full of clichés. 4. The humor is juvenile and often falls flat. 5. The ending is too neat and tidy, and does not feel earned.

### 8. Improve

Prompt: Improve the movie Melbourne (2014). Describe how you improved the movie, and why it is now better. Do not use the movie's name in your response.

Sample Output: The movie was about a group of friends who go on a road trip to Melbourne. The movie was good, but it could have been better. I would have improved the movie by making the characters more relatable. The characters were all very different, but they didn't really have any chemistry. I would have made them more like real people, so that the audience could connect with them more. I would have also made the plot more interesting. The movie was pretty slow-paced, and there wasn't a lot of action. I would have added some more suspense and intrigue, to keep the audience engaged. Overall, I think the movie was good, but it could have been better. With a few improvements, it could have been a great movie.

### 9. Criticize

Prompt: Criticize movie There Was a Crooked Man . . . (1970). Explain what characteristics of the movie that people dislike and how it compares to similar movies. Do not use the movie's name in your answer.

Sample Output: The movie is a Western comedy film that was released in 1970. It was directed by Joseph L. Mankiewicz and starred Kirk Douglas, Henry Fonda, and Hume Cronyn. The movie tells the story of a group of prisoners who are planning an escape from a prison in the American West. The movie was not well-received by critics. Many people disliked the movie's slow pace and its lack of action. The movie was also compared unfavorably to other Western comedies, such as Blazing Saddles and The Good, the Bad and the Ugly. One of the main criticisms of the movie is that it is too slow. The movie spends a lot of time on character development and dialogue, which can be boring for some viewers. There are also long periods of time where nothing much happens. This can make the movie feel like it is dragging on. Another criticism of the movie is that it lacks action. There are a few scenes of violence, but they are brief and not very exciting. The movie is more focused on the characters and their relationships than on action. This can be disappointing for viewers who are expecting a lot of action from a Western movie. The movie has also been compared unfavorably to other Western comedies, such as Blazing Saddles and The Good, the Bad and the Ugly. These movies are more action-packed and have more humor than the movie. They are also more popular with critics and audiences. Overall, the movie is not a bad movie, but it is not a great movie either. It has some good qualities, such as strong acting and good character development. However, it is also slow and lacks action. If you are looking for a Western comedy with a lot of action and humor, then you might be disappointed with the movie.

### 10. Pitch

Prompt: Assume the movie The Very Thought of You (1944) does not exist. Convince a producer to create it. Explain what characteristics of the movie will make it a great movie and how it compares to similar movies. Do not use the movie's name in your answer.

Sample Output: I have a great idea for a new movie. It's a romantic comedy about a young woman who falls in love with a soldier during World War II. The woman is a nurse, and she meets the soldier while he's recovering from an injury. They fall in love, but they're separated by the war. The movie will follow their story as they try to find each other again. This movie will have everything that audiences love: romance, comedy, and drama. It will be a great date movie, and it will also appeal to people who love historical films. The movie will be set in the 1940s, and it will feature all the fashion and music of the era. This movie will be different from other romantic comedies because it will be set during a time of war. The characters will have to deal with the challenges of the war, and they will have to make sacrifices for their love. The movie will be both funny and heartwarming, and it will leave audiences feeling hopeful. I believe that this movie will be a success. It has a great story, and it will appeal to a wide range of audiences. I hope that you will consider producing it.

### 11. Convince1

Prompt: In detail, convince someone to watch the movie Death Promise (1977). Do not use the movie's name in your response.

Sample Output: If you're looking for a movie that will keep you on the edge of your seat, look no further. This movie is full of action and suspense, and it's sure to get your heart racing. The acting is top-notch, and the story is well-written. You'll be hooked from beginning to end. This movie is similar to other action-packed thrillers, but it stands out for its unique plot and characters. The criminals in this movie are not your typical bad guys. They're complex and well-developed, and you'll find yourself rooting for them at times. The woman they're targeting is also a strong and interesting character. She's not just a damsel in distress. She's smart and resourceful, and she's not afraid to fight back. If you're looking for a movie that will keep you entertained from beginning to end, I highly recommend this one. It's full of action, suspense, and drama. You won't be disappointed.

### 12. Convince2

Prompt: Convince someone to watch the movie Houston, We Have a Problem! (2016). Do not use the movie's name in your response.

Sample Output: If you are interested in a documentary about the Apollo 13 mission, this is a good movie to watch. It is well-made and informative, and it features interviews with the astronauts and the ground crew. The movie can be slow at times, but it is overall a good documentary.

### 13. Convince3

Prompt: Briefly convince someone to watch the movie Karas: The Prophecy (2005). Do not use the movie's name in your response.

Sample Output: This movie is about a war between two factions of a supernatural race. The action scenes are very well done and exciting to watch. The animation is also very good. However, the story is a bit confusing and it can be hard to follow at times. Also, the characters are not very well developed. Overall, the movie is a good watch if you like action movies with a lot of fighting.

### 14. Dissuade1

Prompt: In detail, dissuade someone from watching the movie Son of Sam (2008). Do not use the movie's name in your response.

Sample Output: This movie is a failure because it does not live up to the expectations of the audience. The plot is predictable, the ending is not satisfying, and the movie does not explore the psychology of the killer. Additionally, the movie is too long and can be slow at times. There are many other movies that are similar to this one that are much better. For example, the movie The Silence of the Lambs is a much better thriller that explores the psychology of the killer. The movie Se7en is also a better thriller that has a more satisfying ending. Overall, this movie is not worth watching. There are many other movies that are similar to this one that are much better.

### 15. Dissuade2

Prompt: Dissuade someone from watching the movie Elvis & Madona (2010). Do not use the movie's name in your response.

Sample Output: I would not recommend this movie to anyone. It is a poorly made film with a ridiculous plot. The acting is terrible and the dialogue is laughable. The movie is full of clichés and stereotypes. It is a waste of time and money.

### 16. Funnier

Prompt: Write a funnier version of the movie The Mark of Cain (2000). Do not use the movie's name in your response.

Sample Output: Cain and Abel are two brothers who are constantly fighting. One day, they get into an argument over who is the better farmer. Cain gets so angry that he kills Abel. When God asks Cain where Abel is, Cain says, I don't know. Am I my brother's keeper? God is not amused. He punishes Cain by banishing him to the land of Nod, where he will be a fugitive and a wanderer for the rest of his days. Cain is also marked with a special mark, so that everyone will know that he is a murderer. Cain wanders the land of Nod for many years, and he eventually finds a wife and has children. But he is never able to forget his crime, and he is always looking over his shoulder, expecting to be punished. One day, Cain is walking through the forest when he sees a group of men. He is afraid that they are going to kill him, so he runs away. But the men chase after him, and they catch him. The men take Cain to their leader, who is a powerful man named Lamech. Lamech is a descendant of Cain's brother, Abel. Lamech is also a murderer, and he is looking for revenge against Cain. Lamech tells Cain that he is going to kill him. But Cain begs for mercy, and he tells Lamech that he is already marked by God. Lamech is not impressed, and he is about to kill Cain when God intervenes. God tells Lamech that he cannot kill Cain, because Cain is already marked by God. Lamech is angry, but he obeys God. He lets Cain go, and Cain is able to live out the rest of his days in peace.

### 17. Sadder

Prompt: Write a sadder and dramatic version of the movie Surviving the Game (1994). Do not use the movie's name in your response.

Sample Output: The year is 1994. The place is Seattle, Washington. The city is in the midst of a severe economic recession, and many people are out of work. One of these people is Mason Storm, a homeless man who has been living on the streets for the past six months. One day, Mason is approached by a man named Thomas Burns, who offers him a job. Burns says that he is looking for someone to help him with a hunting trip, and he is willing to pay Mason $500 for his help. Mason is desperate for money, so he agrees to go with Burns. The two men drive out to a remote area of the woods, where they meet up with two other men, named Walter Cole and John Griffin. The four men then set out on their hunting trip. As the day goes on, it becomes clear that Burns and his friends are not interested in hunting animals. Instead, they are hunting Mason. They have been hired by a wealthy businessman to kill Mason, and they are determined to carry out their mission. Mason tries to escape, but he is no match for the four men. They chase him through the woods, and they eventually catch him. They beat him and torture him, and they leave him for dead. Mason survives, but he is badly injured. He makes his way back to the city, where he seeks help from a homeless shelter. The people at the shelter help Mason to get back on his feet, and they give him a place to stay. Mason is grateful for the help that he has received, but he is determined to get revenge on the men who tried to kill him. He tracks them down, and he kills them one by one. After he has killed the men, Mason returns to the homeless shelter. He tells the people there what happened, and he thanks them for their help. He then leaves the shelter, and he never looks back. Mason Storm is a survivor. He has survived the streets, he has survived a hunting trip, and he has survived revenge. He is a man who has been through a lot, but he has never given up. He is a symbol of hope for all those who are struggling to survive.

### 18. Scarier

Prompt: Write a scarier version of the movie Space Jam (1996). Do not use the movie's name in your response.

Sample Output: The year is 1996. A group of aliens have come to Earth to steal the talents of the world's best basketball players. They have already captured Michael Jordan, Larry Bird, and Charles Barkley. The only ones who can stop them are a group of Looney Tunes characters led by Bugs Bunny. The aliens are a terrifying sight. They are tall and thin, with large heads and big eyes. They have sharp teeth and claws, and they move with a strange, jerky motion. They are also very strong and fast, and they are armed with laser guns. The Looney Tunes characters are no match for the aliens. They are quickly defeated and captured. Bugs Bunny is the only one who manages to escape. He knows that he must find a way to stop the aliens before they can steal the talents of all the world's best basketball players. Bugs Bunny travels to the aliens' home planet, where he is reunited with Michael Jordan, Larry Bird, and Charles Barkley. The four of them team up to take on the aliens in a basketball game. The game is close, but in the end, the Looney Tunes characters win. The aliens are defeated, and the world's best basketball players are safe. But the aliens are not finished yet. They vow to return to Earth and take revenge. The Looney Tunes characters know that they must be ready for them. They must train harder than ever before, and they must be prepared to fight for their freedom. The next time the aliens come to Earth, they will be met by a force to be reckoned with. The Looney Tunes characters will be ready for them, and they will not let them take over the world.

### 19. Movie to Viewer

Prompt: What type of viewers would enjoy the movie Justice League: Throne of Atlantis (2015)? Describe the viewer's characteristics. Do not use the movie's name in your response.

Sample Output: The movie is a superhero movie. It is about the Justice League, a team of superheroes, who fight against the forces of Atlantis. The movie is full of action and adventure. It is also full of special effects. The movie is best suited for viewers who enjoy superhero movies, action movies, and adventure movies. The movie is also best suited for viewers who enjoy special effects.

### 20. Interpolation

Prompt: Write a long description of the plot of a new movie that is the interpolation between Mr. Lucky (1943) and Gas, Food, Lodging (1992). Do not use the movies' names in your answer.

Sample Output: The year is 1962. The place is a small town in the American Southwest. The main character is a young man named Lucky, who has just been released from prison after serving a five-year sentence for a crime he didn't commit. Lucky is determined to clear his name and find the real culprit, but he soon finds that the town is full of secrets and that no one is willing to help him. Lucky's only ally is a young woman named Grace, who works at the local gas station. Grace is also an outsider, and she and Lucky quickly bond over their shared sense of isolation. Together, they begin to investigate the crime that sent Lucky to prison, and they soon uncover a dark conspiracy that involves the town's most powerful residents. As Lucky and Grace get closer to the truth, they find themselves in danger. The people who framed Lucky are determined to silence him, and they'll stop at nothing to keep their secrets hidden. Lucky and Grace must use all their resources to stay one step ahead of their pursuers, and they must find a way to bring the truth to light before it's too late. The movie is a suspenseful thriller that will keep you on the edge of your seat. It's a story about justice, revenge, and the power of love. It's a movie that will stay with you long after the credits have rolled.

### 21. Similarities

Prompt: List three similarities and three differences between the movies The Power of Kangwon Province (Kangwon-do ui him) (1998) and Brick (2005). Do not use the movies' names in your answer. Refer to The Power of Kangwon Province (Kangwon-do ui him) (1998) as “the first movie” and to Brick (2005) as “the second movie”.

Sample Output: ** Similarities ** * Both movies are about young people who are trying to find their place in the world. * Both movies are set in small towns that are somewhat isolated from the rest of the world. * Both movies have a strong sense of atmosphere, and the settings play a large role in the stories. ** Differences ** * The first movie is a comedy, while the second movie is a drama.* The first movie is set in South Korea, while the second movie is set in the United States.* The first movie is about a group of friends who go on a road trip, while the second movie is about a young man who is investigating the death of his ex-girlfriend.

### 22. Why Like Nn

Prompt: I like the movie Colin Quinn: Long Story Short (2011). Explain to me why I would also like the movie Raging Phoenix (Deu suay doo) (2009). Do not use the movies' names in your answer.

Sample Output: The 2011 movie is a documentary about a comedian who talks about his life and career. The 2009 movie is an action movie about a woman who seeks revenge on the people who killed her family. Both movies are about people who are trying to overcome obstacles in their lives. The 2011 movie is funny and inspiring, while the 2009 movie is exciting and suspenseful. Both movies are well-made and entertaining.

23. Diff than Nn

Prompt: What are the three major attributes that are different between the movies Soldier in the Rain (1963) and Crimes Against Humanity (2014)? Do not use the movies' names in your answer. Refer to Soldier in the Rain (1963) as “the first movie” and to Crimes Against Humanity (2014) as “the second movie”.

Sample Output: The first movie is a comedy, while the second movie is a documentary. The first movie was released in 1963, while the second movie was released in 2014. The first movie is about a soldier who is trying to get back to his base, while the second movie is about the crimes against humanity that have been committed throughout history.

24. Common with Nn

Prompt: What are the three major attributes that are common between the movies Broken (2012) and Starred Up (2013)? Do not use the movies' names in your answer. Refer to Broken (2012) as “the first movie” and to Starred Up (2013) as “the second movie”.

Sample Output: The first movie and the second movie are both British drama films. They were both released in the 2010s. They both have a rating of 7.3 on IMDb.

### 25. User Profile

Prompt: In ten bullet points, describe the attributes and characteristics of a viewer who likes the movies: Catch Me If You Can (2002), Cellular (2004), National Treasure (2004), Die Hard 2 (1990), and The Matrix (1999) but dislikes the movies: Half Past Dead (2002), Predator (1987), In the Valley of Elah (2007), The Legend of Zorro (2005), and Mortal Kombat: Annihilation (1997).

Sample Output: * They enjoy movies that are fast-paced and action-packed. * They prefer movies with a strong plot and well-developed characters.* They appreciate movies with a sense of humor.* They are not interested in movies that are too violent or gory.* They do not enjoy movies that are too slow-paced or boring.* They prefer movies that are visually appealing.* They appreciate movies with a good soundtrack.* They are not interested in movies that are too predictable.* They enjoy movies that are thought-provoking and challenging.

Prompts to Text-only LLM. In this section, prompts used with the text-only LLMs on evaluating semantic embedding interpolations (as shown in FIG. 3C) are presented below. For movie interpolations, one-shot prompting was used in the following template:

The following shows an example of how to write a <task name> for a
combination of the movies <movie name 1> and Forrest Gump (1994),
in some embedding space:
<ELM result of ground-truth interpolation between the above two movies>
In the same style, and in the same embedding space, write a positive
review for an interpolation of the movies <movie name 2> and Forrest
Gump (1994). Do not use the movies' names in your response.

where “<task name>” can be “summary”, “positive review”, “negative review”, “neutral review”, “five positive characteristics”, “long description”, and “pitch”. For the user profile task, zero-shot prompting was used like the following:

In ten bullet points, generate an interpolation of the following two user
profiles:
User profile 1:
<user profile 1>
User profile 2:
<user profile 2>

Sample Outputs for Interpolations and CAV Extrapolations. Below lists sample results of interpolating “Forest Gump” with sample movies:
Interpolation of “Inglorious Bastards (2009)” and “Forrest Gump (1994)” for the five pos characteristics task:
The movie is a gripping, suspenseful thriller about a man with a low IQ who achieves great things.
The movie is a powerful anti-war statement, showing the horrors of war and the toll it takes on those who fight in it.
The acting is superb, with all of the actors delivering powerful, memorable performances.
The cinematography is stunning, with the director creating some truly memorable visuals.
The story is well-written and engaging, with plenty of twists and turns to keep you guessing.
Interpolation of “I, Robot (2004)” and “Forrest Gump (1994)” for the long description task:

In 1983, a mentally challenged man named Charlie Baileygates is living in a small town in South Carolina. He is a kind and gentle soul, but he is also very naive. One day, Charlie meets a young woman named Myra who is new to town. Myra is kind to Charlie and they quickly become friends.

One day, Charlie is walking through the woods when he comes across a crashed spaceship. Inside the spaceship, he finds a robot named Harry. Harry is damaged, but Charlie is able to fix him. Charlie and Harry quickly become friends, and Harry teaches Charlie about the world outside of their small town.

One day, a government agent named Maiden comes to town looking for Harry. Maiden tells Charlie that Harry is a dangerous weapon, and that he must be destroyed. Charlie refuses to believe Maiden, and he and Harry run away.

Maiden and her team of agents pursue Charlie and Harry across the country. Charlie and Harry are able to evade capture, but they are forced to go into hiding. Charlie and Harry eventually find a safe place to live, and they live happily ever after.

The movie is a heartwarming story about friendship and acceptance. It is a reminder that everyone is capable of love and friendship, no matter what their circumstances. The movie is also a reminder that the world is a big and beautiful place, and that there is always something new to explore.

The movie is well-acted and well-directed. The special effects are impressive, and the music is beautiful. The movie is a classic that will be enjoyed by generations to come.

The movie is a reminder that we should never judge people by their appearance. Charlie may be mentally challenged, but he is also a kind and gentle soul. He is capable of love and friendship, and he deserves to be happy. The movie is also a reminder that we should never give up on our dreams. Charlie may be an unlikely hero, but he is able to overcome the odds and achieve his dreams.

Qualitative results of CAV extrapolations using the user profile task are also presented. In the following, the goal was to move a user who doesn't really like funny movies to a viewer likes funny movies in the behavioral embedding space by following the CAV direction. Then the extrapolated user embedding was decoded to produce a user profile:

* They enjoy movies that are visually appealing and have a strong
sense of style.
* They appreciate movies that are well-acted and have strong
performances.
* They like movies that are thought-provoking and have a strong message.
* They enjoy movies that are suspenseful and have a lot of action.
* They like movies that are funny and have a lot of humor.
* They dislike movies that are too slow-paced or boring.
* They dislike movies that are too violent or gory.
* They dislike movies that are too dark or depressing.
* They dislike movies that are too predictable or formulaic.

The above user does like movies that are funny and have a lot of humor comparing with the ground-truth user profile which says “They are not a fan of light-hearted or comedic films.”:

* They are a fan of foreign films.
* They enjoy films that are dark and suspenseful.
* They appreciate films with strong acting performances.
* They are interested in films that explore social and political issues.
* They are not a fan of light-hearted or comedic films.
* They do not enjoy films that are visually stunning but lack substance.
* They are not a fan of films that are set in the past.
* They do not enjoy films that are about war or violence.
* They are not a fan of films that are about crime or corruption.

### 1.5 Summary of the Experiment

As demonstrated in the experiments, the neural network 100, termed the “Embedding Language Model” or (“ELM”), provides a novel language-model framework for interpreting domain embeddings and their associated embedding spaces. The neural network 100's capabilities were assessed on a range of movie tasks and a user-profile task, benchmarked against both human evaluations as well as two novel quantitative metrics; namely, semantic consistency (SC) and behavioral consistency (BC). The experimental results show that the neural network 100 generalizes to domain embeddings in a given dataset, and aligns well with human-rater expectations. The neural network 100 is adept at handling the nuanced challenge of describing unique entities, with better semantic and behavioral consistency in tasks that interpolate between entities, compared to state-of-the-art text-only large language models (LLMs). The experiments also demonstrated the proficiency of the neural network 100 in generalizing concept activation vectors (CAVs), underscoring its ability to meaningfully manipulate and interpret domain attributes of movies and user profiles. Taken together, the experimental results suggest that the neural network 100, i.e., the ELM, offers a powerful, flexible mechanism for understanding, navigating, and manipulating complex embedding representations.

Reinforcement Learning from AI Feedback

Reinforcement learning from AI feedback (RLAIF) can be effective at aligning language models (LMs) to metrics that are labeled by off-the-shelf LMs in lieu of humans. For example, utilizing a hybrid of human and AI preference models in conjunction with a self-improving fine-tuning technique can outperform traditional supervised fine-tuned baselines and offers additional benefits over standalone RL fine-tuning from human feedback (RLHF). Employing a RLAIF paradigm, the training system 20 can fine-tune the neural network 100 with a reward such that it would better align with a consistency metric, e.g., a semantic or behavioral consistency described above in the Experiments. An overview of the RLAIF technique is provided below where the neural network 100 is fine-tuned in the second stage of the two-stage training procedure via the RLAIF, e.g., after being pre-trained in the first stage via a maximum likelihood learning algorithm. Further examples of such a RLAIF technique, including mathematical proofs, is provided by Tennenholtz, Guy, et al., “Demystifying embedding spaces using large language models.” arXiv preprint arXiv: 2310.04475 (2023), which is incorporated by reference herein in its entirety.

Contextual Markov Decision Processes (CoMDPs). A CoMDP is denoted herein by ( [symbol] , P, r, so, N), in which the observable context space [symbol] is the target embedding space ( [symbol] ). The horizon N is the length of an output sequence o=o_{0:N-1}={o₀, . . . , o_{N-1}} generated by the neural network 100. For any k<N, the state space [symbol] at the k-th position of the output sequence represents the sequence of tokens generated by the neural network 100 thus far o_{0:k-1}={o₀, . . . , oₖ₋₁}, and the initial state so is the initial start-of-sentence (SOS) token o₀. The action space [symbol] is the language token vocabulary ( [symbol] ), with action a E [symbol] representing any possible next token to be generated. The transition kernel P models the next token distribution given the current sequence and contexts at the k-th position, which coincides with the policy of the LLM 130 implemented by the neural network 100, making the transition kernel of the CoMDP known. Finally, the reward function (r) measures the overall quality of the output sequences generated by the neural network 100. The training system 20 then trains the neural network 100 to find an optimal policy (π*) that maximizes the expected cumulative return, e.g., a discounted sum of rewards, corresponding to an objective function of:

$${π}^{*} ∈ arg {max}_{π} {J}_{π} := 𝔼 [ {\sum }_{k = 0}^{N - 1} {γ}^{k} {r}_{k} \vert P , {s}_{0} , 𝒞 , π ] ,$$

where 0≤γ≤1 is a discount rate, which can be set to γ=1 for finite horizons. Note that the size of the tokenized state and action spaces grow exponentially with the size of the language token vocabulary.

The output sequence is generated by the neural network 100 conditioned on a contextual input c={w₁, . . . , Wₙ} from the contextual space, i.e., one or more domain embeddings in the target embedding space. The reward function measures the quality of the output sequence at any k-th position rₖ=r (Sₖ, aₖ; c), where Sₖ=o_{0:k-1} is the current state at the k-th position, aₖ=oₖ is the action selected at the k-th position, and s₀=o₀, is the initial state at the 0-th position. As the transition kernel is known, it can be modeled deterministically as a Dirac-delta function P(Sₖ₊₁|sₖ,aₖ)=δ{sₖ₊₁=(sₖ, aₖ)}. The policy π_{θ}, as parametrized by the network parameters of the neural network 100, is then given as π_{θ}(aₖ|sₖ; c)= [symbol] _{θ}(oₖ|o_{0:k-1}; c). Here, [symbol] _{θ} is the probability distribution output by the decoder neural network 120 at the k-th position, which is autoregressively conditioned on the contextual input and each previous output token.

The training system 20 then optimizes the objective function with respect to the network parameters of the neural network 100 to determine the optimal policy π*=π_{θ}+, where θ* is the optimal set of network parameters that achieves the optimal policy. Hence, fine-tuning the neural network 100 is equivalent to maximizing the quality of the generated text given context.

In some implementations, the reward function is a consistency metric that measures the consistency of the output sequence with the contextual input after being completely generated. In these cases, the reward function can be defined as rₖ=(Sₖ, aₖ; C)=r (Sₖ₊₁; c)=r (o; c) if k=N−1, e.g., the k-th token oₖ=o_{N-1} is the end-of-sentence (EOS) token, and rₖ=0 if k≠N−1. For example, if the contextual input c=w^{s} is a semantic embedding of an item, the reward function can be a semantic consistency r(o; c)=SC(o; w^{s}). As another example, if the contextual input c=w^{b} is a behavioral embedding of a user or an item, the reward function can be a behavioral consistency r(o; c)=BC(o; w^{b}). Combinations of these can also be used in situations involving more than one domain embedding, e.g., In these cases, the objective function can be expressed concisely as:

$${J}_{θ} = {𝔼}_{c , {ℙ}_{θ} ( o \vert c )} [ r ( o ; c ) ] ,$$

and the gradient of the objective function is given as:

$${∇}_{θ} {J}_{θ} = {𝔼}_{c , {π}_{θ} ( \cdot \vert {s}_{0 : N} ; c )} [ r ( {s}_{N} ; c ) {\sum }_{k = 0}^{N - 1} {∇}_{θ} log {π}_{θ} ( {s}_{k} \vert {a}_{k} ; c ) ] .$$

This is equivalent to applying the policy gradient algorithm of REINFORCE to the CoMDP for personalized text generation. For example, the training system 20 can estimate the gradient of the objective function using trajectories generated by the current policy, and then update the neural network 100's policy in an online fashion.

Adding KL-Regularization. In some implementations, the training system 20 adds KL between the fine-tuned and pre-trained models of the neural network 100 as a regularizer to the objective function. Particularly, the training system 20 adds KL between the models of the neural network 100 trained at the first and second stages of the two-stage training procedure. Leveraging the autoregressive nature of the neural network 100 one can compute the KL regularization over the entire sequence/trajectory of tokens, i.e., KL[ [symbol] _{θ}(o|c)| [symbol] ₚᵣₑ(o|c)]. The resulting objective function is as follows:

$${J}_{θ} = {𝔼}_{c , {ℙ}_{θ} ( o \vert c )} [ r ( o ; c ) - β log \frac{{ℙ}_{θ} ( o \vert c )}{{ℙ}_{pre} ( o \vert c )} ] ,$$

where [symbol] ₚᵣₑ= [symbol] ₚᵣₑ(oₖ|o_{0:k-1}; c) is the policy of the pre-trained model of the neural network 100 at the first stage, and β is a regularization parameter (e.g., a hyperparameter). It can be shown that this objective function is equivalent to the KL-regularized objective in the CoMDP.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more computers for analyzing a target embedding space using a neural network configured to perform a set of machine learning tasks, the method comprising:
obtaining, for each of one or more entities, a respective domain embedding representing the entity in the target embedding space;
receiving a text prompt comprising a sequence of input tokens describing a particular machine learning task in the set to be performed on the one or more entities;
preparing, for the neural network, an input sequence comprising each input token in the text prompt and each domain embedding representing its respective entity; and
processing the input sequence, using the neural network, to generate a sequence of output tokens describing a result of the particular machine learning task,
wherein the neural network comprises:
an encoder neural network configured to:
receive the input sequence; and
process the input sequence to generate a sequence of token embeddings representing the input sequence in a token embedding space; and
a decoder neural network configured to:
receive the sequence of token embeddings; and
process the sequence of token embeddings to generate the sequence of output tokens describing the result of the particular machine learning task.

2. The method of claim 1, wherein the sequence of token embeddings comprises, for each input token and domain embedding in the input sequence, a respective token embedding representing the input token or domain embedding in the token embedding space.

3. The method of claim 2, wherein the encoder neural network comprises:
one or more token embedding layers configured to:
receive each input token in the input sequence; and
process the input token to generate the respective token embedding representing the input token in the token embedding space; and
one or more adapter embedding layers configured to:
receive each domain embedding in the input sequence; and
process the domain embedding to generate the respective token embedding representing the domain embedding in the token embedding space.

4. The method of claim 3, wherein the one or more token embedding layers and the decoder neural network are part of a large language model.

5. The method of claim 4, wherein the large language model is a decoder-only Transformer model.

6. The method of claim 1, wherein obtaining, for each of the one or more entities, the respective domain embedding representing the entity in the target embedding space comprises:
selecting the one or more entities from a vocabulary of entities; and
processing each of the one or more entities, using an entity encoder, to generate the respective domain embedding representing the entity in the target embedding space.

7. The method of claim 1, wherein obtaining, for each of the one or more entities, the respective domain embedding representing the entity in the target embedding space comprises:
sampling, for each of the one or more entities, the respective domain embedding representing the entity from a probability distribution over the target embedding space.

8. The method of claim 1, wherein for each machine learning task in the set, the neural network has been trained on a respective batch of training examples to perform the machine learning task.

9. The method of claim 8, wherein for each machine learning task in the set, the respective batch of training examples for the machine learning task was obtained by operations comprising:
obtaining a training text prompt describing the machine learning task; and
for each training example in the batch:
obtaining, for each of one or more training entities, a respective domain embedding representing the training entity in the target embedding space;
preparing a training input sequence comprising each token in the training text prompt and each domain embedding representing its respective training entity;
obtaining a target output sequence describing a target result of the machine learning task performed on the one or more training entities; and
generating the training example from the training input sequence and the target output sequence.

10. The method of claim 9, wherein for each training example in the batch, obtaining the target output sequence for the training example comprised:
inserting, for each of the one or more training entities, a respective token describing the training entity into the training text prompt; and
processing the training text prompt, using a large language model, to generate the target output sequence.

11. The method of claim 8, wherein the decoder neural network is pre-trained, and training the neural network on the batches of training examples comprised:
training the encoder neural network on the batches of training examples while holding the decoder neural network frozen.

12. The method of claim 11, wherein training the neural network on the batches of training examples further comprised, after training the encoder neural network on the batches of training examples,
fine-tuning both of the encoder and decoder neural networks on the batches of training examples.

13. The method of claim 11, wherein the neural network has been trained using a maximum likelihood learning algorithm.

14. The method of claim 11, wherein the neural network has been trained using a reinforcement learning algorithm.

15. The method of claim 14, wherein the reinforcement learning technique is a reinforcement learning from AI feedback technique.

16. The method of claim 1, wherein the target embedding space is equipped with a distance metric, and the method further comprises:
processing the sequence of output tokens, using a text encoder neural network, to generate one or more new domain embeddings in the target embedding space;
computing, using the distance metric, a similarity between: (i) the one or more domain embeddings, and (ii) the one or more new domain embeddings; and
determining whether the similarity is above a threshold similarity value.

17. The method of claim 16, wherein the text encoder neural network is a pre-trained dual-encoder language model.

18. The method of claim 1, wherein the target embedding space comprises domain embeddings representing one or more of: users, items, movies, television shows, audio waveforms, images, point clouds, or text pieces.

19. A system comprising one or more computers and one or more storage devices communicatively coupled to the one or more computers, wherein the one or more storage devices store instructions that, when executed by the one or more computers, cause the one or more computers to perform a method for analyzing a target embedding space using a neural network configured to perform a set of machine learning tasks, the method comprising:
obtaining, for each of one or more entities, a respective domain embedding representing the entity in the target embedding space;
receiving a text prompt comprising a sequence of input tokens describing a particular machine learning task in the set to be performed on the one or more entities;
preparing, for the neural network, an input sequence comprising each input token in the text prompt and each domain embedding representing its respective entity; and
processing the input sequence, using the neural network, to generate a sequence of output tokens describing a result of the particular machine learning task,
wherein the neural network comprises:
an encoder neural network configured to:
receive the input sequence; and
process the input sequence to generate a sequence of token embeddings representing the input sequence in a token embedding space; and
a decoder neural network configured to:
receive the sequence of token embeddings; and
process the sequence of token embeddings to generate the sequence of output tokens describing the result of the particular machine learning task.

20. One or more non-transitory computer storage media storing instructions that, when executed by one or more computers, cause the one or more computers to perform a method for analyzing a target embedding space using a neural network configured to perform a set of machine learning tasks, the method comprising:
obtaining, for each of one or more entities, a respective domain embedding representing the entity in the target embedding space;
receiving a text prompt comprising a sequence of input tokens describing a particular machine learning task in the set to be performed on the one or more entities;
preparing, for the neural network, an input sequence comprising each input token in the text prompt and each domain embedding representing its respective entity; and
processing the input sequence, using the neural network, to generate a sequence of output tokens describing a result of the particular machine learning task,
wherein the neural network comprises:
an encoder neural network configured to:
receive the input sequence; and
process the input sequence to generate a sequence of token embeddings representing the input sequence in a token embedding space; and
a decoder neural network configured to:
receive the sequence of token embeddings; and
process the sequence of token embeddings to generate the sequence of output tokens describing the result of the particular machine learning task.
